(19) United States
(12) Patent Application Publication
(10) Pub. No.: US 2015/0092273 A1
(43) Pub. Date: Apr. 2, 2015

(54) INTERFERENCE FILTER, OPTICAL FILTER DEVICE, OPTICAL MODULE, AND ELECTRONIC APPARATUS

(71) Applicant: Seiko Epson Corporation, Tokyo (JP)

(72) Inventor: Akira SANO, Shiojiri (JP)

(21) Appl. No.: 14/487,367

(22) Filed: Sep. 16, 2014

(30) Foreign Application Priority Data
Sep. 27, 2013 (JP) 2013-201045

(51) Int. Cl. G02B 26/00

(52) U.S. Cl. CPC G02B 26/001; G02B 5/0816
USPC 359/578

(57) ABSTRACT

A variable wavelength interference filter includes a stationary reflecting film formed of a plurality of layers, an outermost layer of which is a stationary conductive layer, and a movable reflecting film, the stationary reflecting film includes a first region opposed to the movable reflecting film and a second region continuing from an outer circumferential edge of the first region to an outside of the first region, and a part of the stationary conductive layer in the second region is a terminal section to which wiring connection can be performed.

### BACKGROUND

1. Technical Field

The present invention relates to an interference filter, an optical filter device, an optical module, and an electronic apparatus.

2. Related Art

A known interference filter has a pair of reflecting films opposed to each other and a gap dimension between the reflecting films is varied to thereby take out the light having a predetermined wavelength (see, e.g., JP-A-11-142752).

In the interference filter of JP-A-11-142752, electrodes are disposed on the respective reflecting films, and by applying a voltage between the electrodes, it becomes possible to vary the dimension of the gap between the reflecting films. Further, a dielectric multilayer film is used as each of the reflecting films, and thus, it is possible to transmit light with a small half bandwidth spectrum (high in resolution).

Incidentally, in the interference filter, in order to remove the charge held on the reflecting films, there have been proposed configurations of disposing an electrode on the reflecting film, such as a configuration having an electrode for preventing the static charge disposed on the reflecting film, or a configuration having electrodes for detecting the capacitance disposed on the respective reflecting films to detect the capacitance between the electrodes. In this case, extraction electrodes extracted from the respective electrodes on the reflecting films to the outside of the reflecting films are formed, and electrical connection from terminals provided to the extraction electrodes to a circuit is performed.

However, if the electrode or the extraction electrode is formed on an end surface (a side surface perpendicular to an upper surface opposed to the other reflecting film) of the reflecting film using an evaporation process, a sputtering process, or the like, there is a problem that the electrode or the extraction electrode, maybe, for example, broken on the end surface. In this case, the electrical conduction to the electrode on the reflecting film cannot appropriately be achieved, and there is a problem that the wiring reliability is degraded. In particular, in the case of using the dielectric multilayer film as the reflecting film as in the case of JP-A-11-142752, since the thickness dimension becomes larger compared to a single layer reflecting film, the risk of breaking increases.

### SUMMARY

An advantage of some aspects of the invention is to provide an interference filter, an optical filter device, an optical module, and an electronic apparatus capable of achieving an improvement of the wiring reliability.

An interference filter according to an aspect of the invention includes a first reflecting film formed of a plurality of layers, an outermost layer of which is a conductive layer, and a second reflecting film, the first reflecting film includes a first region opposed to the second reflecting film and a second region continuing from an outer circumferential edge of the first region to an outside of the first region, and a part of the conductive layer in the second region is a terminal section to which wiring connection can be performed.

In this aspect of the invention, the outermost surface of the first reflecting film is a conductive layer, the first reflecting film includes the first region opposed to the second reflecting film and the second region continuing outward from the first region, and a part of the second region forms the terminal section to which external wiring, for example, can be connected.

In such a configuration, by connecting the wiring to the terminal section in the second region, it results that the entire conductive layer of the first reflecting film is electrically connected. Therefore, it is possible to make the conductive layer disposed in the first region of the first reflecting film function as an electrode, and it is possible to prevent charging in the first reflecting film, and to perform detection of the capacitance. On this occasion, in this aspect of the invention, the outermost layer of the first reflecting film is the conductive layer, and the conductive layer is also disposed so as to extend from the first region to the second region. Therefore, the risk of breaking can be reduced, and thus the wiring reliability in the interference filter can be enhanced compared to the case in which, for example, the connection electrode extending from the surface of the reflecting film to the outer circumferential portion of the substrate provided with the reflecting film through an end surface of the reflecting film is separately disposed.

Further, even in the case in which, for example, the first reflecting film is disposed on a substrate, the substrate is provided with a recessed portion such as a groove and a projected portion such as a projection, and the first reflecting film is formed so as to traverse on such recessed portion and projected portion, the slopes of the recessed portion and the projected portion can be smoothed by the first reflecting film formed of the plurality of layers, and therefore, it results that the conductive layer as the outermost surface of the plurality of layers is disposed on a smooth slope or plane, and breaking of the conductive layer can be suppressed. Therefore, the improvement of the wiring reliability in the interference filter can be achieved irrespective of the shape of the substrate on which the first reflective film is to be disposed.

In the interference filter according to the aspect of the invention described above, it is preferable that the second reflecting film is formed of a plurality of layers, an outermost layer of which is a conductive layer, and includes a third region opposed to the first region of the first reflecting film, and a fourth region continuing from an outer circumferential edge of the third region to an outside of the third region, and a part of the conductive layer in the fourth region is a terminal section to which wiring connection can be performed.

With this configuration, the second reflecting film is also formed of a plurality of layers, and the outermost surface thereof forms the conductive layer. Further, the second reflecting film includes the third region opposed to the first region of the first reflecting film and the fourth region extending outward form the third region, and a terminal section to which the wiring connection can be performed is disposed in apart of the fourth region. Therefore, similarly to the first reflecting film, the second reflecting film can also be made to function as the electrode. Further, similarly to the first reflecting film described above, since the conductive layer is formed so as to extend from the third region to the fourth region, similarly to the aspect of the invention described above, the risk of breaking can be reduced, and the wiring reliability in the interference filter can be improved.

In the interference filter according to the aspect of the invention described above, it is preferable that there are further included a first substrate provided with the first reflecting film, a second substrate provided with the second reflecting film, and opposed to the first substrate, a first electrode provided to the first substrate, and a second electrode provided to the second substrate, and opposed to the first electrode, the first electrode is disposed outside the first region in a planar view in which the first substrate is viewed from a substrate thickness direction, and the second electrode is disposed on the conductive layer of the second reflecting film.

According to this configuration, since the first electrode and the second electrode are disposed so as to be opposed to each other, by applying a voltage between these electrodes, the gap dimension between the first region of the first reflecting film and the third region of the second reflecting film can be changed due to the electrostatic attractive force. Thus, it is possible to change the wavelength of the light to be emitted from the interference filter.

On this occasion, since the second electrode is disposed on the conductive layer of the second reflecting film, for example, by setting the terminal section of the fourth region in the second reflecting film to a reference potential (e.g., a ground potential), both of the third region of the second reflecting film and the second electrode can be set to the same reference potential.

In this case, for example, if the same reference potential is set to the terminal section of the first reflecting film, the same potential is set to both of the first region in the first reflecting film and the third region of the second reflecting film, and therefore, the Coulomb force can be inhibited from occurring. Further, only by setting the potential of the first electrode to a desired value, a desired voltage difference can easily be set between the first electrode and the second electrode.

In the interference filter according to the aspect of the invention described above, it is preferable that a gap dimension between the first electrode and the second electrode is smaller than a gap dimension between the conductive layer in the first region of the first reflecting layer and the conductive layer in the third region of the second reflecting film.

In the electrostatic actuator in which a voltage is applied between the first electrode and the second electrode to change the gap dimension using the electrostatic attractive force as described above, the shorter the distance between the electrodes is, the more difficult the control of the gap dimension becomes. In contrast, if the gap dimension between the electrodes is set to be larger than the gap dimension between the conductive layer of the first reflecting film and the conductive layer of the second reflecting film as described above, the gap accuracy when driving can be improved.

In the interference filter according to the aspect of the invention described above, it is preferable that the conductive layer is a metal oxide having a light transmissive property with respect to a predetermined wavelength band.

With this configuration, a metal oxide having a light transmissive property is used as the conductive layer described above. It is sufficient for the light transmissive property described here to be a light transmissive property with respect to a predetermined wavelength band set in advance in accordance with the intended purpose of the interference filter. In such a configuration, it is possible to reduce the disadvantage that the light with the wavelength band described above is absorbed by the conductive layer in the interference filter, and thus, the deterioration of the performance of the interference filter can be suppressed. Further, by using a metal oxide in the outermost surface, deterioration or the like is difficult to occur, and the deterioration of the performance of the interference filter can be suppressed to thereby achieve a longer product life compared to the case of using, for example, a metal film or an alloy film.

In the interference filter according to the aspect of the invention described above, it is preferable that the terminal section is provided with a metal film.

In the case of forming the conductive layer using the metal oxide as described above, when performing wiring on the terminal section, the contact resistance becomes high. In contrast, in the configuration described above, the metal film is provided to the terminal section. In this case, since it becomes possible to perform wiring on the metal film, increase in the contact resistance can be suppressed.

In the interference filter according to the aspect of the invention described above, it is preferable that there are further included a first substrate provided with the first reflecting film, a second substrate provided with the second reflecting film, and an electrode disposed on at least one of the first substrate and the second substrate, and the electrode and the metal film is formed of the same material.

With this configuration, the metal film described above is formed of the same material as those of the electrodes disposed on the first substrate and the second substrate. In this case, the metal film can be formed at the same time as the formation of the electrode disposed on the first substrate or the second substrate, and thus, the production efficiency can be improved.

In the interference filter according to the aspect of the invention described above, it is preferable that there is further included a second substrate provided with the second reflecting film, and the second substrate is provided with a connection electrode connected to the terminal section of the conductive layer of the first reflecting film.

With this configuration, the connection electrode to be connected to terminal section of the conductive layer of the first reflecting film is provided to the second substrate. According to such a configuration, it is possible to collect the electrode terminals on which the wiring connection is performed in one substrate (the second substrate), and thus the efficiency in performing the wiring connection such as wire bonding can be improved.

In the interference filter according to the aspect of the invention described above, it is preferable that the first reflecting film and the second reflecting film are each formed of a plurality of layers including a dielectric multilayer film.

With this configuration, since the dielectric multilayer film having high reflectance with respect to a predetermined wavelength band is used as each of the reflecting films, a half bandwidth of the light emitted from the interference filter becomes small, and the resolution can be increased.

An optical filter device according to another aspect of the invention includes an interference filter provided with a first reflecting film formed of a plurality of layers, an outermost layer of which is a conductive layer, and a second reflecting film, and a housing adapted to house the interference filter, the first reflecting film includes a first region opposed to the second reflecting film and a second region continuing from an outer circumferential edge of the first region to an outside of the first region, and a part of the conductive layer in the second region is a terminal section to which wiring connection can be performed.

In this aspect of the invention, the first reflecting film is formed of a plurality of layers, and the outermost surface of the first reflecting film is formed of a conductive layer. Further, the first reflecting film is disposed so as to extend from the first region opposed to the second reflecting film to the second region located outside the first region, and a part of the second region forms the terminal section. Therefore, similarly to the aspects of the invention described above, by connecting the wiring to the terminal section, the first region of the first reflecting film can be made to function as the electrode, and thus, the wiring reliability can be improved.

Further, since the interference filter is housed in the housing, foreign matters can be inhibited from adhering to the reflecting film, for example, and the interference filter can also be protected from an impact or the like.

An optical module according to still another aspect of the invention includes an interference filter provided with a first reflecting film formed of a plurality of layers, an outermost layer of which is a conductive layer, and a second reflecting film, and a light receiving section adapted to receive light emitted from the interference filter, the first reflecting film includes a first region opposed to the second reflecting film and a second region continuing from an outer circumferential edge of the first region to an outside of the first region, and a part of the conductive layer in the second region is a terminal section to which wiring connection can be performed.

In this aspect of the invention, the wiring reliability can be improved due to the same configuration as those of the aspects of the invention described above. Therefore, also in the optical module including the present interference filter, the wiring reliability can be improved.

An electronic apparatus according to yet another aspect of the invention includes an interference filter provided with a first reflecting film formed of a plurality of layers, an outermost layer of which is a conductive layer, and a second reflecting film, and a control section adapted to control the interference filter, the first reflecting film includes a first region opposed to the second reflecting film and a second region continuing from an outer circumferential edge of the first region to an outside of the first region, and a part of the conductive layer in the second region is a terminal section to which wiring connection can be performed.

In this aspect of the invention, the wiring reliability can be improved due to the same configuration as those of the aspects of the invention described above. Therefore, also in the electronic apparatus including the present interference filter, the wiring reliability can be improved.

### BRIEF DESCRIPTION OF THE DRAWINGS

Embodiments of the invention will be described with reference to the accompanying drawings, wherein like numbers reference like elements.

FIG. 1 is a block diagram showing a schematic configuration of a spectroscopic measurement device according to a first embodiment of the invention.

FIG. 2 is a plan view showing a schematic configuration of a variable wavelength interference filter according to the first embodiment.

FIG. 3 is a cross-sectional view along the A-A′ line shown in FIG. 2.

FIG. 4 is a plan view showing a schematic configuration of a stationary substrate of the variable wavelength interference filter according to the first embodiment.

FIG. 5 is a plan view showing a schematic configuration of a movable substrate of the variable wavelength interference filter according to the first embodiment.

FIGS. 6A through 6D are schematic diagrams each showing a state of a stationary substrate forming process according to the first embodiment.

FIGS. 7A through 7C are schematic diagrams each showing a state of a movable substrate forming process according to the first embodiment.

FIG. 8 is a cross-sectional view showing a schematic configuration of an optical filter device according to a second embodiment of the invention.

FIG. 9 is a cross-sectional view showing a variable wavelength interference filter according to another embodiment of the invention.

FIG. 10 is a plan view of a movable substrate of the variable wavelength interference filter shown in FIG. 9 viewed from a stationary substrate side.

FIG. 11 is a block diagram showing a schematic configuration of a colorimetric device as an example of an electronic apparatus according to the invention.

FIG. 12 is a schematic diagram of a gas detection device as another example of the electronic apparatus according to the invention.

FIG. 13 is a block diagram showing a control system of the gas detection device shown in FIG. 12.

FIG. 14 is a block diagram showing a schematic configuration of a food analysis device as another example of the electronic apparatus according to the invention.

FIG. 15 is a schematic diagram showing a schematic configuration of a spectroscopic camera as another example of the electronic apparatus according to the invention.

### DESCRIPTION OF EXEMPLARY EMBODIMENTS

### First Embodiment

A first embodiment of the invention will hereinafter be explained with reference to the accompanying drawings.

### Configuration of Spectroscopic Measurement Device

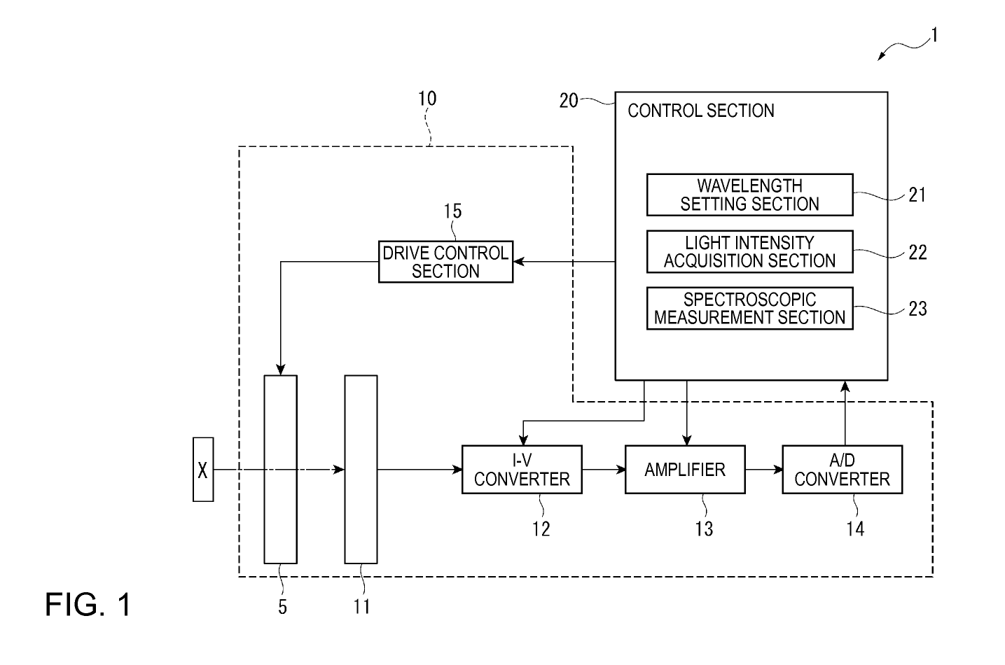

FIG. 1 is a block diagram showing a schematic configuration of a spectroscopic measurement device according to the present embodiment.

The spectroscopic measurement device 1 is an example of an electronic apparatus according to an embodiment of the invention, and is a device for analyzing the intensities of light at respective wavelengths in measurement target light having been reflected by, for example, a measurement object X to thereby measure the dispersion spectrum. It should be noted that although in the present embodiment, the example of measuring the measurement target light reflected by the measurement object X is described, in the case of using a light emitting body such as a liquid crystal panel as the measurement object X, it is possible to use the light emitted from the light emitting body as the measurement target light.

Further, as shown in FIG. 1, the spectroscopic measurement device 1 is provided with an optical module 10, and a control section 20 for processing a signal output from the optical module 10.

### Configuration of Optical Module

The optical module 10 is provided with a variable wavelength interference filter 5, a detector 11, an I-V converter 12, an amplifier 13, an A/D converter 14, and a drive control section 15.

The optical module 10 guides the measurement target light reflected by the measurement object X to the variable wavelength interference filter 5 through an incident optical system (not shown), and then receives the light, which has been transmitted through the variable wavelength interference filter 5, using the detector 11 (a light receiving section). Then, a detection signal output from the detector 11 is output to the control section 20 via the I-V converter 12, the amplifier 13, and the A/D converter 14.

### Configuration of Variable Wavelength Interference Filter

Next, the variable wavelength interference filter 5 to be incorporated in the optical module 10 will be explained.

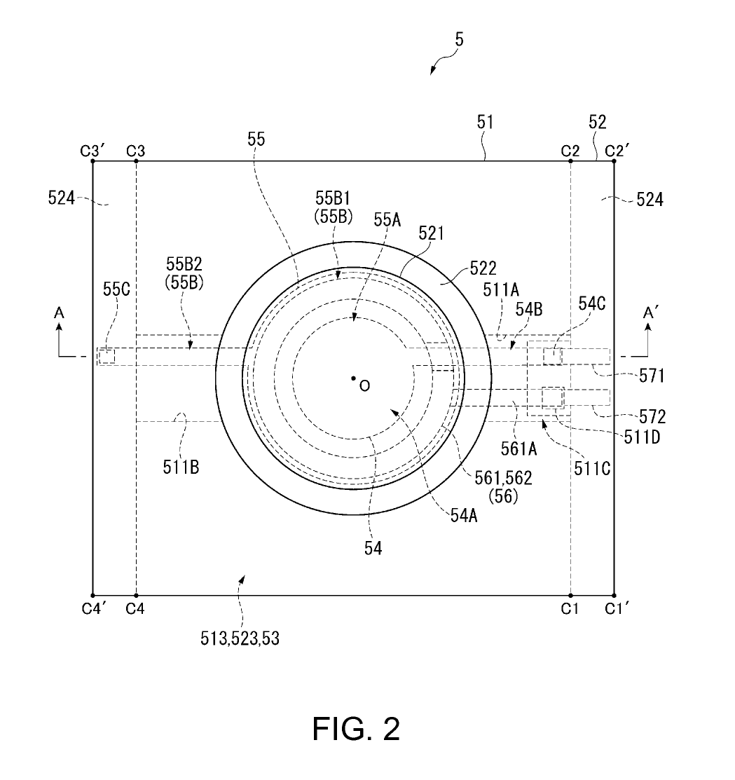

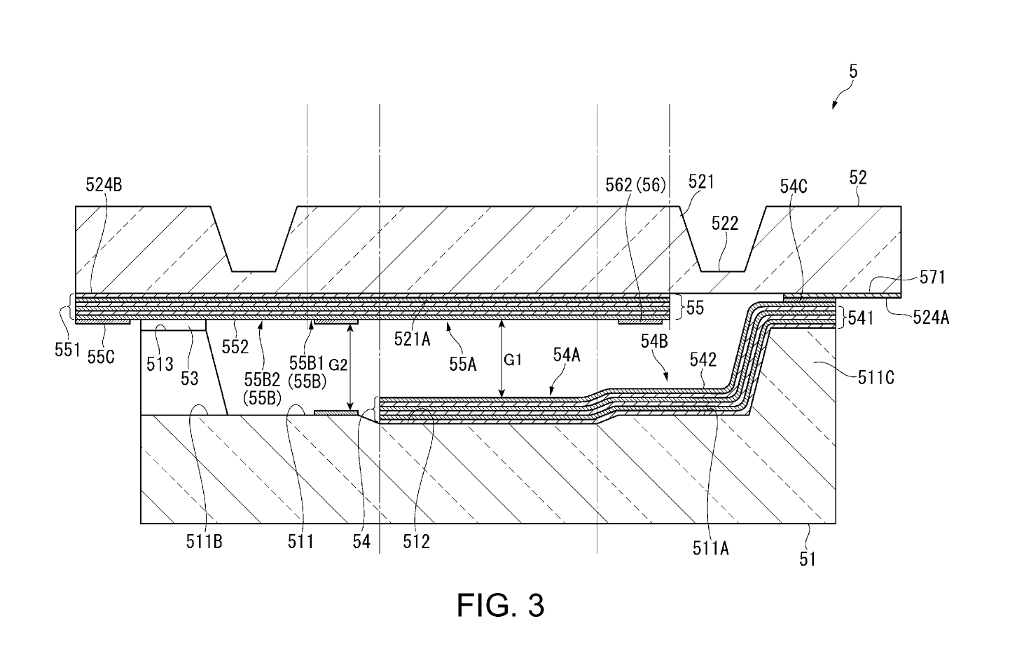

FIG. 2 is a plan view showing a schematic configuration of the variable wavelength interference filter 5. FIG. 3 is a cross-sectional view in the case of cutting the variable wavelength interference filter 5 along the A-A′ line shown in FIG. 2.

As shown in FIGS. 2 and 3, the variable wavelength interference filter 5 is provided with a stationary substrate 51 as a first substrate according to an embodiment of the invention, and a movable substrate 52 as a second substrate according to an embodiment of the invention. The stationary substrate 51 and the movable substrate 52 are each made of a variety of types of glass such as soda glass, crystalline glass, quartz glass, lead glass, potassium glass, borosilicate glass, or alkali-free glass, or a quartz crystal, for example. Further, the stationary substrate 51 and the movable substrate 52 are integrally configured by a first bonding section 513 of the stationary substrate 51 and a second bonding section 523 of the movable substrate 52 being bonded to each other with a bonding film 53 formed of, for example, a plasma-polymerized film consisting primarily of siloxane.

A stationary reflecting film 54 constituting a first reflecting film according to an embodiment of the invention is disposed on a surface of the stationary substrate 51, the surface being opposed to the movable substrate 52, and a movable reflecting film 55 constituting a second reflecting film according to an embodiment of the invention is disposed on a surface of the movable substrate 52, the surface being opposed to the stationary substrate 51. The stationary reflecting film 54 is opposed to the movable reflecting film 55 via a gap G1.

Further, the variable wavelength interference filter 5 is provided with an electrostatic actuator 56 used for adjusting (varying) the gap dimension of the gap G1. The electrostatic actuator 56 is constituted by a stationary electrode 561 constituting a first electrode provided to the stationary substrate 51 and a movable electrode 562 constituting a second electrode provided to the movable substrate 52.

It should be noted that in the explanation below, a planar view viewed from the substrate thickness direction of the stationary substrate 51 or the movable substrate 52, namely a planar view of the variable wavelength interference filter 5 viewed from the stacking direction of the stationary substrate 51 and the movable substrate 52, is referred to as a filter planar view. Further, in the present embodiment, the center point of the stationary reflecting film 54 and the center point of the movable reflecting film 55 coincide with each other in the filter planar view, and the center points of these reflecting films 54, 55 in the planar view are denoted with a symbol O.

### Configuration of Stationary Substrate

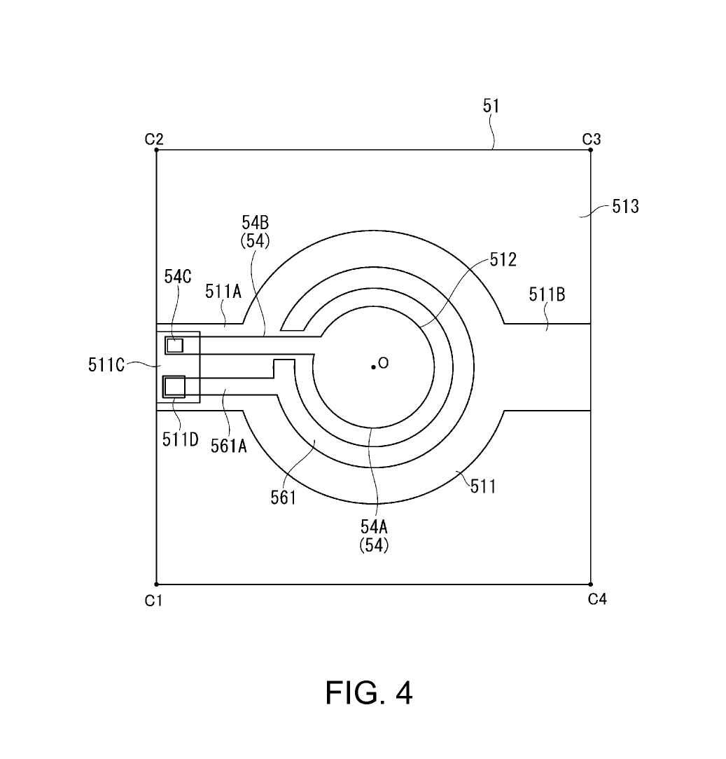

FIG. 4 is a planar view of the stationary substrate 51 viewed from the movable substrate 52 side.

As shown in FIGS. 3 and 4, the stationary substrate 51 is provided with a first groove 511 and a second groove 512 each formed using, for example, an etching process.

The first groove 511 is formed to have a ring-like shape cantered on the filter center point O of the stationary substrate 51 in the filter planar view. The second groove 512 is a groove formed to have a circular shape centered on the filter center point O in the filter planar view, and is larger in depth dimension than the first groove 511.

Further, the stationary substrate 51 is provided with a third groove 511A and a fourth groove 511B each contiguous to the first groove 511. The third groove 511A has a groove bottom surface coplanar with a groove bottom surface of the first groove 511, and extends to a side C1-C2 of an outer circumferential edge of the stationary substrate 51. The fourth groove 511B has a groove bottom surface coplanar with the groove bottom surface of the first groove 511, and extends to a side C3-C4 of the outer circumferential edge of the stationary substrate 51. Further, the third groove 511A is provided with a bump 511C projecting toward the movable substrate 52.

The first drive electrode 561 constituting the electrostatic actuator 56 is disposed on the groove bottom surface of the first groove 511. The stationary electrode 561 can be directly disposed on the groove bottom surface of the first groove 511, or can also be disposed via another thin film (layer) or the like.

The stationary electrode 561 is formed to have a circular arc shape (C shape) centered on the filter center point O, and is provided with an opening of the C shape disposed in a part adjacent to the third groove 511A (i.e., the stationary electrode 561 is split ring shaped). Further, a stationary extraction electrode 561A is contiguous to an outer circumferential edge of the stationary electrode 561. As shown in FIG. 4, the stationary extraction electrode 561A is disposed so as to extend to the bump 511C along the third groove 511A. Here, the bump 511C is provided with a thick auxiliary section 511D having the same thickness dimension as that of the stationary reflecting film 54 and the stationary extraction electrode 561A is disposed on an upper surface (a surface opposed to the movable substrate 52) of the thick auxiliary section 511D.

As a material for forming such stationary electrode 561 and stationary extraction electrode 561A, there can be cited, for example, a metal film made of Au or the like, and a metal laminate body made of Cr/Au or the like.

It should be noted that although in the present embodiment, there is shown a configuration of disposing the single stationary electrode 561 on the groove bottom surface of the first groove 511, it is also possible to adopt, for example, a configuration (a dual electrode configuration) in which two concentric electrodes centered on the filter center point O are disposed.

As described above, the second groove 512 is formed to have a roughly circular shape coaxial with the first groove 511 and having a radial dimension smaller than that of the first groove 511. The groove bottom surface of the second groove 512 is a plane parallel to the groove bottom surface of the first groove 511, and a movable surface 521A (described later) of the movable substrate 52.

Further, the stationary reflecting film 54 is disposed on the groove bottom surface of the second groove 512.

It should be noted that in the present embodiment, a reflecting film including a dielectric multilayer body is used as each of the reflecting films 54, 55. Therefore, since the film thickness dimension becomes larger compared to the case of using a single layer reflecting film, the stationary reflecting film 54 is disposed on the groove bottom surface of the second groove 512. However, the invention is not limited to the configuration described above, and in the case in which, for example, an initial value of the gap G1 between the reflecting films 54, 55 is set to a smaller value depending on the wavelength band to be the object of the measurement by the spectroscopic measurement device 1, it is also possible to adopt a configuration in which a projection section projecting from the central portion of the first groove 511 toward the movable substrate 52 is disposed, and the stationary reflecting film 54 is disposed on a surface of the projection section opposed to the movable substrate 52.

As shown in FIGS. 2 through 4, in the filter planar view, the stationary reflecting film 54 includes a first region 54A having a circular shape covering the groove bottom surface of the second groove 512, and a second region 54B connected outward to the outer circumferential edge of the first region 54A, and extending from the first groove 511 and the third groove 511A to the bump 511C through the opening of the C shape of the stationary electrode 561.

Further, as shown in FIG. 3, the stationary reflecting film 54 is configured including a dielectric multilayer film 541 having high refractive index layers and low refractive index layers alternately stacked on each other, and a stationary conductive layer 542 disposed on the dielectric multilayer film 541, and constituting the outermost surface of the stationary reflecting film 54. As the dielectric multilayer film 541, there can be cited, for example, a laminate body having TiO₂ as the high refractive index layers and SiO₂ as low refractive index layers. The stationary conductive layer 542 is formed of an electrically conductive metal oxide having a light transmissive property with respect to a wavelength band in which the measurement is performed with the spectroscopic measurement device 1, and there can be used, for example, an indium-based oxide such as indium gallium oxide (InGaO), indium tin oxide (Sn doped indium oxide; ITO), Ce doped indium oxide (ICO), or fluorine doped indium oxide (IFO), a tin-based oxide such as antimony doped tin oxide (ATO), fluorine doped tin oxide (FTO), or tin oxide (SnO₂), and a zinc-based oxide such as Al doped zinc oxide (AZO), Ga doped zinc oxide (GZO), fluorine doped zinc oxide (FZO), or zinc oxide (ZnO). Further, indium zinc oxide (IZO; registered trademark) formed of an indium-based oxide and a zinc-based oxide can also be used.

Further, a part of the second region 54B of the stationary reflecting film 54 located on the bump 511C constitutes a terminal section in the first reflecting film according to an embodiment of the invention, and as shown in FIGS. 3 and 4, a stationary terminal film 54C as a metal film according to an embodiment of the invention is disposed on the terminal section. The stationary terminal film 54C can be formed of the same material as that of the stationary electrode 561, or can also be formed using other metal film materials. Further, the stationary terminal film 54C is smaller in thickness dimension than the dielectric multilayer film 541.

In the present embodiment, in the stationary substrate 51, a steep slope or an edge is formed to cause a step in a boundary between the first groove 511 and the second groove 512 and a boundary between the third groove 511A and the bump 511C in some cases. However, when the dielectric multilayer film 541 of the stationary reflecting film 54 is formed, the dielectric multilayer film 541 is stacked so as cover the step, and therefore, the step becomes a gentle slope (e.g., the sharp corners near the lower surface of the multilayer film become rounded corners near the upper surface of the multiplayer film). Therefore, it results that the conductive layer 542 on the outermost surface is formed as a gentle slope or a flat surface, and thus, breaking in the second region 54B is prevented.

Therefore, in the stationary reflecting film 54, the stationary conductive layer 542 on the outermost surface continues from the first region 54A to the second region 54B, and is able to transmit an electric signal input to the stationary terminal film 54C to the stationary conductive layer 542 on the first region 54A of the stationary reflecting film 54. Further, it becomes possible to release the charge on the stationary conductive layer 542 of the first region in the stationary reflecting film 54 externally from the stationary terminal film 54C.

Further, it is also possible to form an antireflection film on a plane of incidence of light (the surface not provided with the stationary reflecting film 54) of the stationary substrate 51 at a position corresponding to the stationary reflecting film 54. The antireflection film can be formed by, for example, alternately stacking low refractive index films and high refractive index films, and decreases the reflectance with respect to the visible light on the surface of the stationary substrate 51, while increasing the transmittance thereof.

### Configuration of Movable Substrate

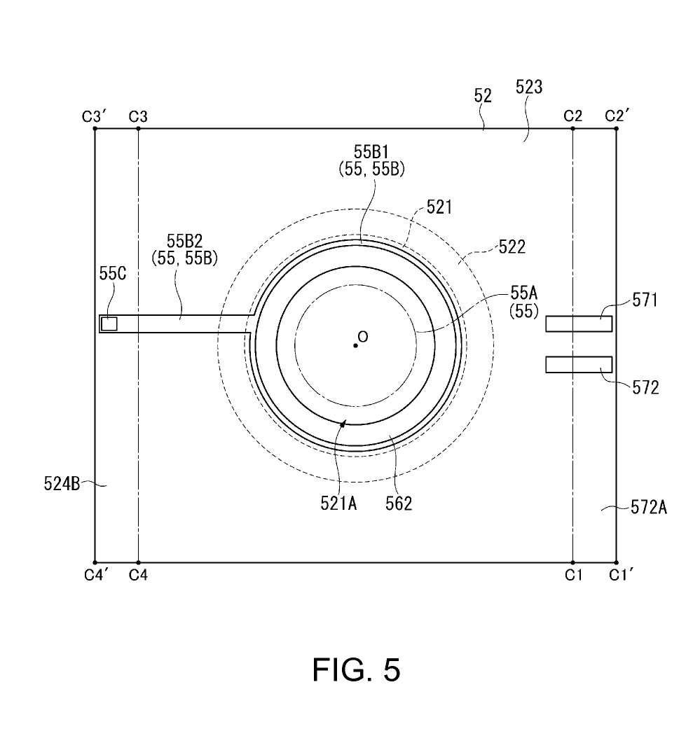

FIG. 5 is a plan view of the movable substrate 52 viewed from the stationary substrate 51 side.

As shown in FIGS. 2, 3, and 5, in the filter planar view, the movable substrate 52 is provided with a movable section 521 having a circular shape centered on the filter center point O, a holding section 522 coaxial with the movable section 521 and for holding the movable section 521, and a second bonding section 523 disposed outside the holding section 522. Further, a side C1′-C2′ of the movable substrate 52 projects outward from the side C1-C2 of the stationary substrate 51, and forms an electric component mounting section 524A. Further, a side C3′-C4′ of the movable substrate 52 projects outward from the side C3-C4 of the stationary substrate 51, and forms an electric component mounting section 524B.

The movable section 521 is formed to have a thickness dimension larger than that of the holding section 522, and is formed in the present embodiment, for example, to have the same thickness dimension as that of the movable substrate 52 (the second bonding section 523). The movable section 521 is formed to have a diameter larger than at least the diameter of the outer circumferential edge of the stationary electrode 561 in the filter planar view. Further, on a movable surface 521A of the movable section 521, the movable surface 521A being opposed to the stationary substrate 51, there is disposed the movable reflecting film 55. The movable reflecting film 55 can also be disposed directly on the movable surface 521A, or disposed on another thin film (layer) disposed on the movable surface 521A.

The movable reflecting film 55 is disposed in the movable surface 521A so as to cover at least an area opposed to the first region 54A of the stationary reflecting film 54 and the stationary electrode 561.

A third region 55A in the movable reflecting film 55 opposed to the first region 54A of the stationary reflecting film 54 is opposed to the first region 54A via the predetermined gap G1. Further, the movable reflecting film 55 has a fourth region 55B contiguous to an outer circumferential edge of the third region 55A. The fourth region 55B includes a fourth ring-like region 55B1 having a ring-like shape continuing throughout the outer circumferential edge of the third region 55A, and a fourth extraction region 55B2 connected outward to the outer circumferential edge of the fourth ring-like region 55B1, and extending to the electric component mounting section 524B through an area opposed to the fourth groove 511B.

Such a movable reflecting film 55 has a similar configuration as that of the stationary reflecting film 54, and is configured including a dielectric multilayer film 551, and a movable conductive layer 552 disposed on the dielectric multilayer film 551, and constituting the outermost surface of the movable reflecting film 55 as shown in FIG. 3. The dielectric multilayer film 551, which has a similar configuration to that of the dielectric multilayer film 541, is formed of, for example, a laminate body having TiO₂ as the high refractive index layers and SiO₂ as low refractive index layers. Similarly to the stationary conductive layer 542, the movable conductive layer 552 is formed of an electrically conductive layer having a light transmissive property with respect to a wavelength band in which the measurement is performed with the spectroscopic measurement device 1, and there can be used, for example, an indium-based oxide such as indium gallium oxide (InGaO), indium tin oxide (Sn doped indium oxide; ITO), Ce doped indium oxide (ICO), or fluorine doped indium oxide (IFO), a tin-based oxide such as antimony doped tin oxide (ATO), fluorine doped tin oxide (FTO), or tin oxide (SnO₂), and a zinc-based oxide such as Al doped zinc oxide (AZO), Ga doped zinc oxide (GZO), fluorine doped zinc oxide (FZO), or zinc oxide (ZnO). Further, indium zinc oxide (IZO; registered trademark) formed of an indium-based oxide and a zinc-based oxide, and so on can also be used.

In the fourth ring-like region 55B1 of the movable reflecting film 55, there is disposed the movable electrode 562 having a ring-like shape opposed to the stationary electrode 561. The movable electrode 562 can be directly disposed on the movable conductive layer 552 on the fourth ring-like region 55B1, or can also be disposed via another conductive film. In other words, the movable conductive layer 552 and the movable electrode 562 are electrically connected to each other to be set to the same electrical potential.

It should be noted that similarly to the stationary electrode 561, as the movable electrode 562, there can be cited, for example, a metal film made of Au or the like, and a metal laminate body made of Cr/Au or the like.

It should be noted that in the present embodiment, although a gap G2 between the stationary electrode 561 and the movable electrode 562 constituting the electrostatic actuator 56 is larger than the gap G1 between the reflecting films 54, as shown in FIG. 3, the gap is not limited to this configuration. In the case, for example, of using an infrared beam or a far infrared beam as the measurement target light, it is also possible to adopt the configuration in which the gap G1 is larger than the gap G2 depending on the wavelength band of the measurement target light.

The fourth extraction region 55B2 of the movable reflecting film 55 extends to the electric component mounting section 524B as described above, and in the electric component mounting section 524B, the terminal section of the second reflecting film is formed, and the movable terminal film 55C as the metal film according to an embodiment of the invention is disposed on the terminal section as shown in FIGS. 3 and 5. The movable terminal film 55C is formed of the same material as that of the movable electrode 562, and the thickness dimension thereof is smaller than that of the dielectric multilayer film 551.

Further, the movable terminal film 55C is electrically connected to the drive control section 15 with wiring connection such as wire bonding.

Further, on the movable substrate 52, there are disposed connection electrodes 571, 572 so as to extend from a region opposed to the bump 511C disposed in the third groove 511A of the stationary substrate 51 to the electric component mounting section 524A. These connection electrodes 571, 572 are each formed of the same material as that of the movable electrode 562 and the movable terminal film 55C, and are each formed of, for example, metal such as Au, or a metal laminate body made of Cr/Au or the like. Here, the connection electrode 571 has contact with the stationary terminal film 54C of the stationary reflecting film 54 to be electrically connected to the stationary terminal film 54C. Further, the connection electrode 572 has contact with the stationary extraction electrode 561A to be electrically connected to the stationary extraction electrode 561A. Further, these connection electrodes 571, 572 are electrically connected to the drive control section 15 by performing the wiring connection such as wire bonding in the electric component mounting section 524A.

The holding section 522 is a diaphragm surrounding the periphery of the movable section 521, and is formed to have a thickness dimension smaller than that of the movable section 521. Such a holding section 522 is easier to be deflected than the movable section 521, and it becomes possible to displace the movable section 521 toward the stationary substrate 51 with a weak electrostatic attractive force. On this occasion, since the movable section 521 has a larger thickness dimension and higher rigidity than those of the holding section 522, the shape variation of the movable section 521 can be suppressed to some extent even in the case in which the movable section 521 is pulled toward the stationary substrate 51 due to the electrostatic attractive force.

It should be noted that although in the present embodiment, the holding section 522 having a diaphragm shape is shown as an example, the shape is not limited to this example, but a configuration of, for example, provided with beam-like holding sections arranged at regular angular intervals centered on the filter center point O of the movable section 521 can also be adopted.

### Configuration of Detector, I-V Converter, Amplifier, and A/D Converter of Optical Module

Next, going back to FIG. 1, the optical module 10 will be explained.

The detector 11 receives (detects) the light transmitted through the variable wavelength interference filter 5, and then outputs a detection signal based on the received light intensity to the I-V converter 12.

The I-V converter 12 converts the detection signal input from the detector 11 into a voltage value, and then outputs the voltage value to the amplifier 13.

The amplifier 13 amplifies the voltage value (the detected voltage), which is input from the I-V converter 12, and corresponds to the detection signal.

The A/D converter 14 converts the detected voltage (an analog signal) input from the amplifier 13 into a digital signal, and then outputs the digital signal to the control section 20.

### Configuration of Drive Control Section

The drive control section 15 applies a drive voltage to the electrostatic actuator 56 of the variable wavelength interference filter 5 based on the control by the control section 20. Thus, the electrostatic attractive force occurs between the stationary electrode 561 and the movable electrode 562 of the electrostatic actuator 56, and the movable section 521 is displaced toward the stationary substrate 51. It should be noted that in the present embodiment, the drive control section 15 sets a reference potential (e.g., a ground potential) to the stationary terminal film 54C, and the movable electrode 562 on the movable conductive layer 552 and the third region 55A of the movable reflecting film 55 are set to the same reference potential. Further, the drive control section 15 sets a potential for setting the gap G1 to a desired gap dimension to the connection electrode 572 electrically connected to the stationary electrode 561. Thus, a voltage corresponding to the potential set to the stationary electrode 561 is applied between the stationary electrode 561 and the movable electrode 562, and the movable section 521 is displaced due to the electrostatic attractive force.

Further, the drive control section 15 sets the reference potential (e.g., the ground potential) to the connection electrode 571 electrically connected to the stationary terminal film 54C of the stationary reflecting film 54. Thus, the stationary conductive layer 542 and the movable conductive layer 552 are set to the same potential, and thus, the Coulomb force can be inhibited from occurring between the first region 54A of the stationary reflecting film 54 and the third region 55A of the movable reflecting film 55, and thus, the accuracy of the drive control by the electrostatic actuator 56 is improved. Further, the charge on each of the stationary conductive layer 542 and the movable conductive layer 552 can be released, and thus, disadvantages due to the charging can also be suppressed.

It should be noted that it is also possible to adopt a configuration in which a high frequency voltage in such a level as not to affect drive of the electrostatic actuator 56 is applied between the stationary conductive layer 542 and the movable conductive layer 552 to thereby make it possible to detect the capacitance between the first region 54A and the third region 55A.

### Configuration of Control Section

Then the control section 20 of the spectroscopic measurement device 1 will be explained.

The control section 20 is configured by combining, for example, a CPU and a memory with each other, and controls an overall operation of the spectroscopic measurement device 1. As shown in FIG. 1, the control section 20 is provided with a wavelength setting section 21, a light intensity acquisition section 22, and a spectroscopic measurement section 23. Further, a memory of the control section 20 stores V−λ data representing a relationship between the wavelength of the light to be transmitted through the variable wavelength interference filter 5 and the drive voltage to be applied to the electrostatic actuator 56 corresponding to the wavelength.

The wavelength setting section 21 sets the target wavelength of the light to be taken out by the variable wavelength interference filter 5, and then outputs an instruction signal, which instructs to apply the drive voltage corresponding to the target wavelength thus set to the electrostatic actuator 56, to the drive control section 15 based on the V−λ data.

The light intensity acquisition section 22 obtains the light intensity of the light with the target wavelength transmitted through the variable wavelength interference filter 5 based on the light intensity obtained by the detector 11.

The spectroscopic measurement section 23 measures the spectrum characteristics of the measurement target light based on the light intensity obtained by the light intensity acquisition section 22.

### Method of Manufacturing Variable Wavelength Interference Filter

Next, a method of manufacturing such a variable wavelength interference filter 5 as described above will be explained with reference to the accompanying drawings.

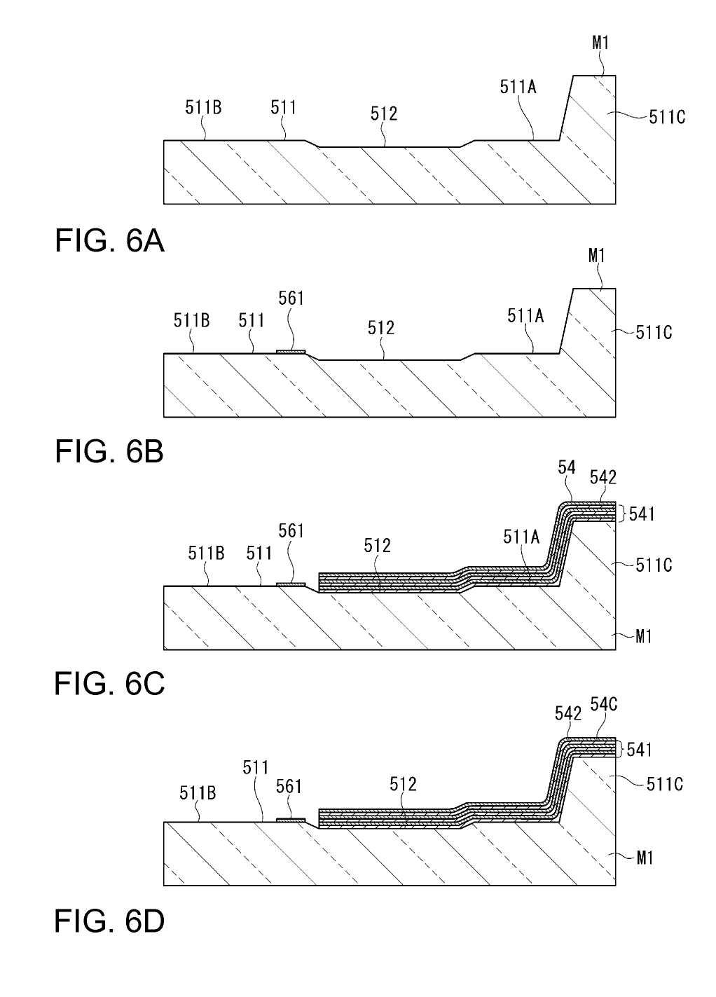

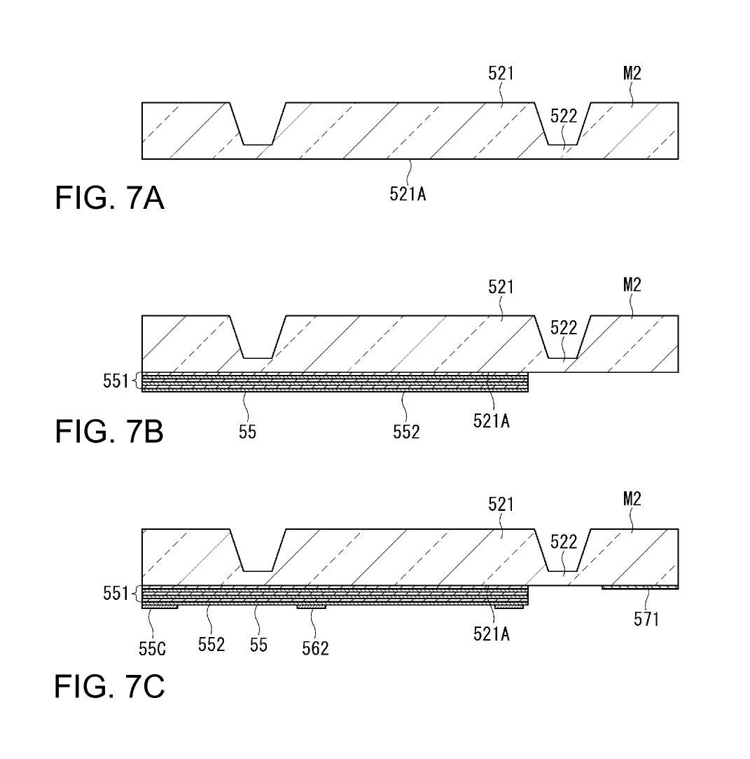

In the manufacturing process of the variable wavelength interference filter 5, a first glass substrate M1 (see FIG. 6A) for forming the stationary substrate 51 and a second glass substrate M2 (see FIG. 7A) for forming the movable substrate 52 are firstly prepared, and then a stationary substrate forming process and a movable substrate forming process are performed. Subsequently, a substrate bonding process is performed to thereby bond the first glass substrate M1 processed in the stationary substrate forming process and the second glass substrate M2 processed in the movable substrate forming process to each other. Further, a cutting process is performed to segment the first glass substrate M1 and the second glass substrate M2 to thereby form the individual variable wavelength interference filter 5.

Each of the processes will hereinafter be explained with reference to the accompanying drawings.

### Stationary Substrate Forming Process

FIGS. 6A through 6D are diagrams each showing the state of the first glass substrate M1 in the stationary substrate forming process.

In the stationary substrate forming process, firstly, fine polishing is performed on both of the surfaces of the first glass substrate M1, which is a manufacturing material of the stationary substrate 51, until the surface roughness Ra becomes equal to or lower than 1 nm to thereby obtain a thickness dimension of, for example, 500 μm.

Then, as shown in FIG. 6A, the substrate surface of the first glass substrate M1 is processed by etching.

Specifically, using a resist pattern patterned using a photolithography method as a mask, a wet-etching process using, for example, a hydrofluoric acid group (e.g., BHF) is repeatedly performed on the first glass substrate M1. Firstly, areas corresponding to the first groove 511, the second groove 512, the third groove 511A, and the fourth groove 511B are etched to a depth position of the first groove 511.

On this occasion, in the third groove 511A, the resist is also formed in apart corresponding to the bump 511C. Thus, a part of the first glass substrate M1 can be made to function as the bump 511C. Further, it is also possible to form the thick auxiliary section 511D by performing partial etching on the bump 511C. It is also possible to separately disposing the thick auxiliary section 511D on the bump 511C with resin or the like.

Subsequently, a part corresponding to the second groove 512 is etched to a desired depth position.

It should be noted that although in the present embodiment, an example of forming the bump 511C by wet etching is described, it is also possible to adopt a configuration of, for example, separately disposing the bump 511C to the third groove 511A.

Then, an electrode material (e.g., a metal film made of Au or the like, a metal laminate body made of Cr/Au or the like, and metal oxide such as ITO) for forming the stationary electrode 561 and the stationary extraction electrode 561A (not shown in FIGS. 6A through 6D) is deposited on the first glass substrate M1 using an evaporation method, a sputtering method, or the like. Then, a resist is applied to the first glass substrate M1, and then the resist is patterned in accordance with the shapes of the stationary electrode 561 and the stationary extraction electrode 561A using a photolithography method. Then, the stationary electrode 561 and the stationary extraction electrode 561A are patterned using a wet-etching process, and then the resist is removed.

Thus, the stationary electrode 561 and the stationary extraction electrode 561A (not shown) are formed as shown in FIG. 6B.

Subsequently, as shown in FIG. 6C, the stationary reflecting film 54 is formed.

In the present embodiment, a laminate body of the dielectric multilayer film 541 and the stationary conductive layer 542 is formed as the stationary reflecting film 54. On this occasion, the resist (a liftoff pattern) is formed on the first glass substrate M1 except the part where the reflecting film is to be formed. Subsequently, a material (e.g., each of the dielectric films constituting the dielectric multilayer film 541, and metal oxide for forming the stationary conductive layer 542) for forming the stationary reflecting film 54 is deposited using a sputtering method, an evaporation method, or the like. Subsequently, the film in unwanted portions is removed using a lift-off process.

On this occasion, even in the case in which a steep slope or an edge exists in the first glass substrate M1 due to the wet-etching process and so on, the dielectric layers are stacked when forming the dielectric multilayer film 541 to thereby make the slope of the step portion gentle. Therefore, when forming the stationary conductive layer 542 on the dielectric multilayer film 541, there is no chance for the stationary conductive layer 542 to be broken at the step portion, and it becomes possible to form the electrically conductive stationary conductive layer 542 throughout an area from the first region 54A to the second region 54B.

Subsequently, as shown in FIG. 6D, the stationary terminal film 54C is formed with respect to the terminal section of the second region 54B. Specifically, for example, a metal film is deposited on the first glass substrate M1 using an evaporation method, a sputtering method, or the like. Then, a resist is applied to the first glass substrate M1, and then the resist is patterned using a photolithography method, and then wet etching is performed to thereby form the stationary terminal film 54C. It should be noted that in the case of using the metal oxide such as ITO as the film material of the stationary electrode 561, it is also possible to form a terminal formed of a metal film with respect to the stationary extraction electrode 561A on the bump 511C at the same time as the formation of the stationary terminal film 54C. Thus, even in the case in which the stationary electrode 561 is formed of a metal oxide, the contact resistance occurring when making the stationary electrode 561 have contact with the connection electrode 572 can be reduced.

According to the process described above, the first glass substrate M1 with a plurality of stationary substrates 51 arranged in an array is manufactured, wherein the stationary reflecting film 54, the stationary electrode 561, and the stationary extraction electrode 561A are arranged in each of the stationary substrates 51.

### Movable Substrate Forming Process

FIGS. 7A through 7C are diagrams each showing the state of the second glass substrate M2 in the movable substrate forming process.

In the movable substrate forming process, firstly, fine polishing is performed on both of the surfaces of the second glass substrate M2, which is a manufacturing material of the movable substrate 52, until the surface roughness Ra becomes equal to or lower than 1 nm to thereby obtain a thickness dimension of, for example, 500 μm.

Then, a Cr/Au layer is formed on the surface of the second glass substrate M2, and then an area corresponding to the holding section 522 is etched with, for example, a hydrofluoric acid group (e.g., BHF) using the Cr/Au layer as an etch mask. Subsequently, by removing the Cr/Au layer used as the etch mask, the substrate shape of the movable substrate 52 is formed as shown in FIG. 7A.

Then, as shown in FIG. 7B, the movable reflecting film 55 is formed. The movable reflecting film 55 can also be formed by substantially the same method as in the case of the stationary reflecting film 54.

Specifically, the resist (a liftoff pattern) is formed on the second glass substrate M2 except the part where the reflecting film is to be formed using a photolithography method or the like. Subsequently, a material (e.g., each of the dielectric films constituting the dielectric multilayer film 551, and metal oxide for forming the movable conductive layer 552) for forming the movable reflecting film 55 is deposited using a sputtering method, an evaporation method, or the like. Subsequently, the film in unwanted portions is removed using a lift-off process.

Subsequently, as shown in FIG. 7C, the movable electrode 562 and the movable terminal film 55C are formed. In the formation of the movable electrode 562 and the movable terminal film 55C, a similar method to the method of forming the stationary electrode 561 in the stationary substrate 51 described above can be used. In the present embodiment, the movable electrode 562 and the movable terminal film 55C are formed on the movable conductive layer 552 in a stacked manner, and each can be formed using the same electrode material. Therefore, it is not necessary to separate the forming process of the movable electrode 562 and the forming process of the movable terminal film 55C from each other, and thus, an improvement of the production efficiency can be achieved.

According to the process described above, the second glass substrate M2 with a plurality of movable substrates 52 arranged in an array is manufactured, wherein the movable electrode 562 and the movable reflecting film 55 are formed in each of the movable substrates 52.

### Substrate Bonding Process

Next, the substrate bonding process and the cutting process will be explained.

In the substrate bonding process, firstly, a plasma-polymerized film consisting primarily of polyorganosiloxane is deposited on each of the first bonding section 513 of the first glass substrate M1 and the second bonding section 523 of the second glass substrate M2 using, for example, a plasma CVD method. Here, the thickness dimension of the bonding film 53 formed by stacking the plasma-polymerized films is set to a level with which the contact pressure in a level with which the connection electrode 571 and the stationary terminal film 54C can electrically be connected to each other is applied. Specifically, the bonding film 53 is formed to have a thickness dimension equal to the total thickness of the connection electrode 571, the dielectric multilayer film 541, the stationary conductive layer 542, and the stationary terminal film 54C, or smaller than the total thickness of the connection electrode 571, the dielectric multilayer film 541, the stationary conductive layer 542, and the stationary terminal film 54C to the extent that the contact pressure described above can be set.

Then, in order to apply the activation energy to the plasma-polymerized films of the first glass substrate M1 and the second glass substrate M2, an O₂ plasma process or a UV process is performed. In the case of the O₂ plasma process, the process is performed for 30 seconds in the condition in which the O₂ flow rate is 1.8×10⁻³ (m³/h), the pressure is 27 Pa, and the RF power is 200 W. Further, in the case of the UV process, the process is performed for 3 minutes using excimer UV (wavelength of 172 nm) as the UV source.

After applying the activation energy to the plasma-polymerized film, an alignment adjustment of the first glass substrate M1 and the second glass substrate M2 is performed, then the first glass substrate M1 and the second glass substrate M2 are made to overlap each other via the plasma-polymerized films, and a weight of, for example, 98 (N) is applied to the bonding section for 10 minutes. Thus, the first glass substrate M1 and the second glass substrate M2 are bonded to each other.

### Cutting Process

Next, the cutting process will be explained.

In the cutting process, the stationary substrate 51 and the movable substrate 52 are carved out chip by chip to form such a variable wavelength interference filter 5 as shown in FIGS. 2 and 3. For cutting the first glass substrate M1 and the second glass substrate M2, a scribing/breaking process or a laser cutting process, for example, can be used.

### Functions and Advantages of First Embodiment

In the present embodiment, the stationary reflecting film 54 is formed of the dielectric multilayer film 541 and the stationary conductive layer 542 disposed on the dielectric multilayer film 541. Further, the stationary reflecting film 54 includes the first region 54A opposed to the movable reflecting film 55, and the second region 54B contiguous to the first region 54A, and the terminal section to be connected to the connection electrode 571 is disposed in the second region 54B.

In such a configuration, the dielectric multilayer film 541 is disposed so as to extend from the first region 54A to the terminal section of the second region 54B, and the stationary conductive layer 542 is disposed on the dielectric multilayer film 541. In this case, since an edge, a steep slope, or the like is not formed on the surface of the dielectric multilayer film 541, the risk of breaking of the stationary conductive layer 542 can be decreased. Therefore, it is possible to improve the wiring reliability in the variable wavelength interference filter 5. Thus, it is possible to improve the equipment reliability also in the optical module 10 and the spectroscopic measurement device 1 using such a variable wavelength interference filter 5.

Further, in the present embodiment, the movable reflecting film 55 is also formed of the dielectric multilayer film 551 and the movable conductive layer 552 disposed on the dielectric multilayer film 551 similarly to the stationary reflecting film 54. Further, the movable reflecting film 55 includes the third region 55A opposed to the stationary reflecting film 54, and the fourth region 55B contiguous to the third region 55A, and the terminal section, which can electrically be connected to the drive control section 15, is disposed in the fourth region 55B.

Therefore, since the risk of breaking of the movable conductive layer 552 can also be decreased in the movable reflecting film 55, the wiring reliability can further be improved, and thus, the equipment reliability in the optical module 10 and the spectroscopic measurement device 1 can be enhanced.

In the present embodiment, the stationary electrode 561 is disposed on the stationary substrate 51, and the movable electrode 562 is disposed on the movable reflecting film 55 disposed on the movable substrate 52.

Therefore, by applying a voltage between the stationary electrode 561 and the movable electrode 562, the dimension of the gap G1 between the reflecting films 54, 55 can be changed, and thus, the light with the desired wavelength can be emitted from the variable wavelength interference filter 5.

Further, the movable electrode 562 is disposed on the movable conductive layer 552, and the reference potential is set to the movable terminal film 55C in the drive control section 15. Therefore, a potential difference can be generated between the stationary electrode 561 and the movable electrode 562 only by setting the potential of the stationary electrode 561. Further, since the charge on the movable conductive layer 552 can be released to the ground circuit of the drive control section 15 through the movable terminal film 55C, the charge on the movable reflecting film 55 can be removed.

In the present embodiment, the gap G2 between the electrodes 561, 562 is larger than the gap G1 between the reflecting films 54, 55. Therefore, accurate drive can be realized when controlling the electrostatic actuator 56.

In the present embodiment, a metal oxide having a light transmissive property with respect to the wavelength band to the measurement target is used as the stationary conductive layer 542 and the movable conductive layer 552. Therefore, absorption of the light or the like in each of the conductive layers 542, 552 can be suppressed when using the variable wavelength interference filter 5.

Further, since the conductive layers 542, 552 are the layers disposed on the outermost surface of the respective reflecting films 54, 55, if a metal film or an alloy film is used as these conductive layers 542, 552, deterioration occurs due to oxidation. In contrast, since in the present embodiment, the metal oxide is used as the conductive layers 542, 552, such deterioration as described above can be suppressed, and thus, longer product life of the variable wavelength interference filter 5 can be achieved.

In the present embodiment, the stationary terminal film 54C is provided to the terminal section of the stationary conductive layer 542, and the movable terminal film 55C is provided to the terminal section of the movable conductive layer 552. In the case of using the metal oxide as the conductive layers 542, 552, there is a disadvantage that the contact resistance becomes high when connecting the wiring or the like in the terminal section. In contrast, in the present embodiment, the wiring can be connected to the terminal films 54C, 55C each made of a metal film, and thus increase in contact resistance can be suppressed.

In the present embodiment, the movable electrode 562 and the movable terminal film 55C are formed of the same electrode material. Therefore, it is possible to form the movable electrode 562 and the movable terminal film 55C at the same time in the same process, and thus, an improvement of the production efficiency can be achieved.

Further, the movable terminal film 55C is smaller in thickness dimension than the dielectric multilayer film 551, and thus, cost reduction can be achieved. The same applies to the stationary terminal film 54C, and the thickness dimension is smaller than that of the dielectric multilayer film 541, and thus, cost reduction can be achieved.

In the present embodiment, the stationary terminal film 54C is connected to the connection electrode 571 of the movable substrate 52, and the stationary extraction electrode 561A is connected to the connection electrode 572 of the movable substrate 52. Therefore, when performing the wiring connection on the variable wavelength interference filter 5, it is sufficient to perform the wiring connection such as wire bonding on the connection electrodes 571, 572 of the electric component mounting section 524A provided to the movable substrate 52 and the movable terminal film 55C of the electric component mounting section 524B, and thus, work efficiency can be improved.

In the present embodiment, the stationary reflecting film 54 has the dielectric multilayer film 541, and the movable reflecting film 55 has the dielectric multilayer film 551. Since such dielectric multilayer films 541, 551 each have a high reflectance with respect to a predetermined wavelength band, it is possible to emit the light with a sharp peak also in the variable wavelength interference filter 5. In other words, the light transmitted through the variable wavelength interference filter 5 becomes the light with a small half bandwidth, and the improvement in resolution can be achieved. Therefore, in the optical module 10 using such a variable wavelength interference filter 5, a more accurate light intensity of the light with a desired wavelength can be detected, and the accuracy of the spectroscopic measurement process in the spectroscopic measurement device 1 can also be improved.

### Second Embodiment

Next, a second embodiment of the invention will be explained with reference to the accompanying drawing.

In the spectroscopic measurement device 1 according to the first embodiment described above, there is adopted the configuration in which the variable wavelength interference filter 5 is directly mounted to the optical module 10. However, some optical modules have a complicated configuration, and there are some cases in which it is difficult to directly mount the variable wavelength interference filter 5 in particular to a small-sized optical module. In the present embodiment, an optical filter device, which makes it possible to easily install the variable wavelength interference filter 5 also to such an optical module, will hereinafter be explained.

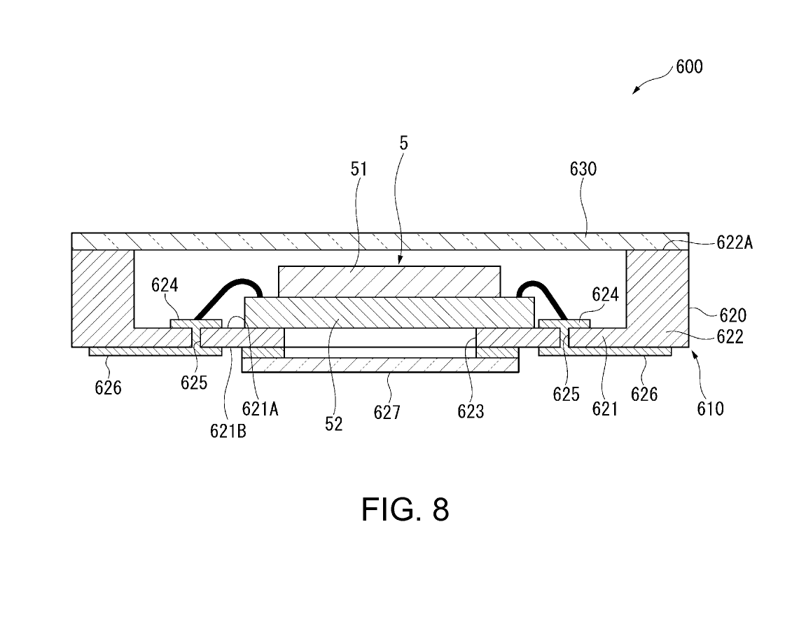

FIG. 8 is a cross-sectional view showing a schematic configuration of the optical filter device according to the second embodiment of the invention.

As shown in FIG. 8, the optical filter device 600 is provided with a housing 610, and the variable wavelength interference filter 5 housed inside the housing 610.

As shown in FIG. 8, the housing 610 is provided with a base 620 and a lid 630. By bonding the base 620 and the lid 630 to each other, a housing space is formed inside, and the variable wavelength interference filter 5 is housed in the housing space.

### Configuration of Base

The base 620 is formed of, for example, ceramic or the like. The base 620 is provided with a pedestal section 621 and a sidewall section 622.

The pedestal section 621 is formed to have a plate shape having, for example, a rectangular outer shape in the filter planar view, and the sidewall section 622 having a cylindrical shape stands in the circumferential portion of the pedestal section 621 towards the lid 630.

The pedestal section 621 is provided with an opening 623 penetrating in the thickness direction. The opening 623 is disposed so as to include the region overlapping the reflecting films 54, 55 in a planar view of viewing the pedestal section 621 in the thickness direction in the state in which the variable wavelength interference filter 5 is housed in the pedestal section 621.

Further, a glass member 627 for covering the opening 623 is bonded to a surface (a base outer surface 621B) of the pedestal 621 on an opposite side to the lid 630. As the bonding method of bonding the pedestal section 621 and the glass member 627, there can be used, for example, low-melting-point glass bonding using a glass frit (low-melting-point glass), which is a scrap of glass obtained by melting a glass material at high temperature and then rapidly cooling it, and bonding with epoxy resin or the like. In the present embodiment, the housing space is airtightly maintained in the state of keeping the reduced pressure. Therefore, it is preferable for the pedestal section 621 and the glass member 627 to be bonded to each other using the low-melting-point glass bonding.

Further, an inner surface (a base inner surface 621A) of the pedestal section 621 opposed to the lid 630 is provided with internal terminal sections 624 to be respectively connected to the connection electrodes 571, 572, and the movable terminal film 55C of the variable wavelength interference filter 5. The internal terminal sections 624, and the connection electrodes 571, 572, and the movable terminal film 55C are respectively connected to each other by, for example, wire bonding using wires made of, for example, Au. It should be noted that although in the present embodiment, the wire bonding is described as an example, it is also possible to use, for example, flexible printed circuits (FPC).

Further, the pedestal section 621 is provided with through holes 625 formed at positions where the internal terminal sections 624 are disposed. The internal terminal sections 624 are connected to external terminal sections 626 disposed on the base outer surface 621B of the pedestal section 621 via the through holes 625.

The sidewall section 622 stands from the edge portion of the pedestal section 621, and surrounds the periphery of the variable wavelength interference filter 5 mounted on the base inner surface 621A. The surface (an end surface 622A) of the sidewall section 622 opposed to the lid 630 is a flat surface parallel to, for example, the base inner surface 621A.

Further, the variable wavelength interference filter 5 is fixed to the base 620 using the fixation member such as an adhesive. On this occasion, the variable wavelength interference filter 5 can be fixed to the pedestal section 621, or can also be fixed to the sidewall section 622. Although the fixation member can be disposed at a plurality of places, it is preferable to fix the variable wavelength interference filter 5 at one place in order to inhibit the stress of the fixation member from being transmitted to the variable wavelength interference filter 5.

### Configuration of Lid

The lid 630 is a transparent member having a rectangular outer shape in a planar view, and is formed of, for example, glass.

As shown in FIG. 8, the lid 630 is bonded to the sidewall section 622 of the base 620. As the bonding method, for example, bonding with the low-melting-point glass can be cited.

### Functions and Advantages of Second Embodiment

In the optical filter device 600 according to the present embodiment described above, since the variable wavelength interference filter 5 is protected by the housing 610, breakage of the variable wavelength interference filter 5 due to an external factor can be prevented.

### Other Embodiments

It should be noted that the invention is not limited to the embodiments described above, but includes modifications, improvements, and so on within a range where the advantages of the invention can be achieved.

In the above description of the embodiments, the metal oxide having a light transmissive property is described as an example of the conductive layers 542, 552, but the conductive layers are not limited to this example. The conductive layers can also be formed of a metal film made of Ag or the like and an alloy film made of an Ag alloy or the like. In this case, there can also be adopted a configuration in which the terminal films 54C, 55C are not provided.

Although in the above description of the embodiments there is described the example in which the stationary reflecting film 54 is formed of the dielectric multilayer film 541 and the stationary conductive layer 542, it is also possible to adopt a configuration in which other reflecting films such as a dielectric layer, a metal layer, or an alloy layer are disposed instead of the dielectric multilayer film 541. The same applies to the movable reflecting film 55.

Although in the above description of the embodiments there is described the example in which the movable terminal film 55C is formed of the same material as that of the movable electrode 562, the materials are not limited to this example. For example, it is also possible that the movable terminal film 55C is formed of Au, and the movable electrode 562 is formed of Al. It should be noted that in this case, since the movable terminal film 55C and the movable electrode 562 cannot be formed at the same time, a process for forming the movable terminal film 55C and a process for forming the movable electrode 562 are separately required.

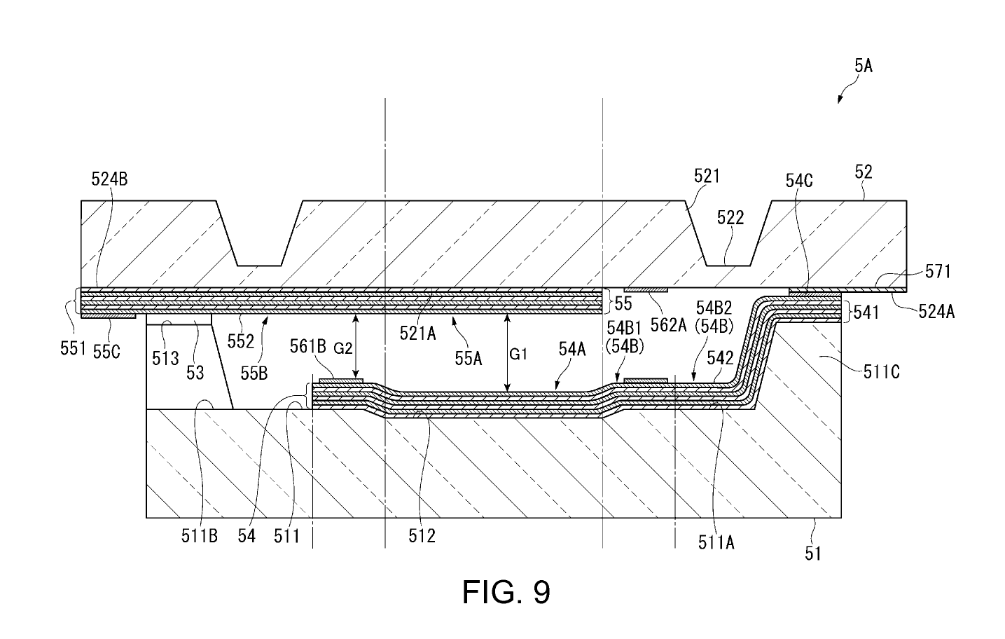

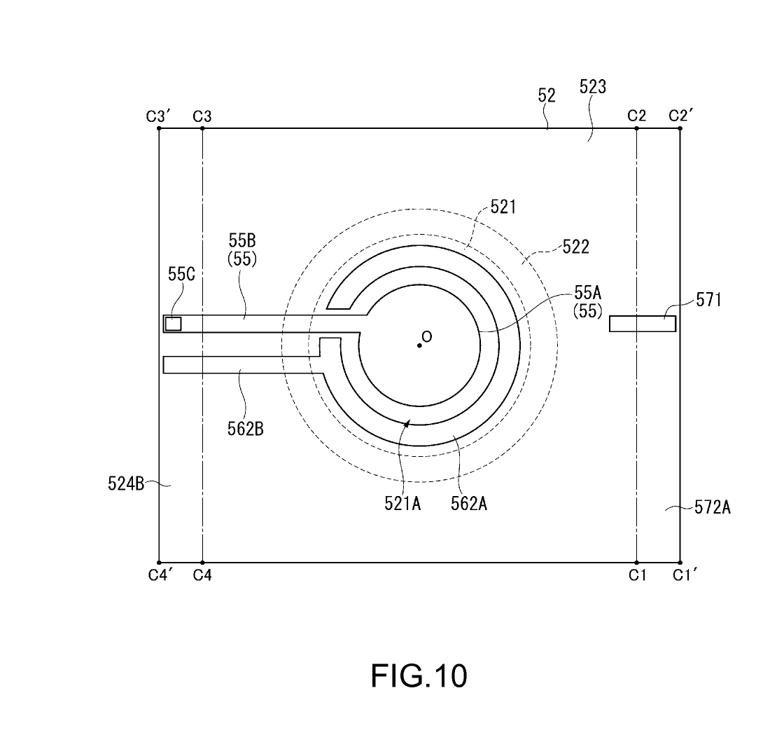

In the above description of the embodiments, there is described the example in which the stationary electrode 561 is disposed on the stationary substrate 51, and is isolated from the stationary conductive layer 542 of the stationary reflecting film 54, and the movable electrode 562 is disposed on the movable conductive layer 552 of the movable reflecting film 55, but the invention is not limited to this example. For example, there can also be adopted a configuration shown in FIGS. 9 and 10.

Here, FIG. 9 is a cross-sectional view showing a variable wavelength interference filter 5A according to another embodiment of the invention. FIG. 10 is a plan view of the movable substrate 52 in FIG. 9 viewed from the stationary substrate 51 side.

As shown in FIG. 9, in this variable wavelength interference filter 5A, the stationary reflecting film 54 is disposed so as to extend from the second groove 512 to a region opposed to at least the movable section 521 of the first groove 511. Specifically, in the present embodiment, the second region 54B in the stationary reflecting film 54 is provided with a second ring-like region 54B1 having a ring-like shape continuing throughout the outer circumferential edge of the first region 54A, and a second extraction region 54B2 connected outward to the outer circumferential edge of the second ring-like region 54B1, and extending to the bump 511C through an area opposed to the third groove 511A.

Further, a stationary electrode 561B having a ring-like shape is formed on the stationary conductive layer 542 of the second ring-like region 54B1 of the stationary reflecting film 54. Similarly to the embodiments described above, the stationary terminal film 54C is disposed at a position in the second extraction region 54B2 corresponding to the bump 511C, and is connected to the connection electrode 571 of the movable substrate 52.

Further, the stationary electrode 561B is formed to have a ring-like shape, and is electrically connected to the conductive layer 541. Therefore, the stationary electrode 561B has the same potential as the conductive layer 541 as the outermost surface of the stationary reflecting film 54.

It should be noted that since the stationary extraction electrode 561A is not provided in this example, the connection electrode 572 becomes unnecessary.

Meanwhile, a movable electrode 562A opposed to the stationary electrode 561B is disposed on a surface of the movable section 521A of the movable substrate 52, the surface being opposed to the stationary substrate 51. The movable electrode 562A is formed to have a circular arc shape (C shape) centered on the filter center point O, and is provided with an opening of the C shape disposed in a part adjacent to the electric component mounting section 524B on the side C3′-C4′ side as shown in FIG. 10. Further, as shown in FIG. 10, the movable extraction electrode 561B is connected to an outer circumferential edge of the movable electrode 562A, and extends to the electric component mounting section 524B.

Further, the fourth region 55B of the movable reflecting film 55 is extracted from the outer circumferential edge of the third region 55A to the electric component mounting section 524B through the opening of the C shape of the movable electrode 562, and the movable terminal film 55C is disposed at a position in the third region 55A corresponding to the electric component mounting section 524B.

In such a variable wavelength interference filter 5A, the stationary electrode 561 and the stationary conductive layer 542 of the stationary reflecting film 54 are set to the same potential, and the reference potential is set to the connection electrode 571 in the drive control section 15. In this case, a potential difference can be generated between the stationary electrode 561 and the movable electrode 562 only by setting the potential of the movable electrode 562.

Further, since the number of places where the terminals are pressed against each other to achieve electrical contact with each other is decreased in the bump 511C, the influence of the stress of the movable section 521 can be reduced.

In the embodiments described above, in the stationary substrate forming process, the stationary reflecting film 54 is formed after forming the stationary electrode 561 and the stationary extraction electrode 561A, and then the stationary terminal film 54C is formed, but the process is not limited to this example.

For example, it is also possible to form the stationary reflecting film 54 before forming the stationary electrode 561 and the stationary extraction electrode 561A, and then form the stationary electrode 561 and the stationary extraction electrode 561A at the same time as the formation of the stationary terminal film 54C. In this case, the production efficiency can be improved.

Further, there is described the configuration in which the stationary electrode 561 is formed to have a circular arc shape (C shape), and the second region 54B of the stationary reflecting film 54 is formed so as to extend to the bump 511C through the opening of the C shape of the stationary electrode 561 in the stationary substrate 51 as an example, but the invention is not limited to this example.

For example, it is also possible to adopt a configuration in which, for example, the stationary electrode 561 is formed to have a ring-like shape, and the second region 54B of the stationary reflecting film 54 is disposed running upon the stationary electrode 561. In this case, even if the thickness dimension of the stationary electrode 561 is large, the stationary reflecting film 54 is formed to have a multilayer structure, and therefore, the risk that the breaking occurs in the stationary conductive layer 542 as the outermost surface in the second region 54B can be reduced.

It is also possible to set the thickness dimensions of the stationary terminal film 54C and the stationary electrode 561 to respective dimensions different from each other. On this occasion, it is sufficient to appropriately change the thickness dimension of the thick auxiliary section 511D of the bump 511C.

In the above description of the embodiments, there is described the example in which the movable electrode 562 is disposed on the movable conductive layer 552 of the movable reflecting film 55, and the movable conductive layer 552 and the movable electrode 562 are set to the same potential, but the invention is not limited to this example.

For example, similarly to the stationary electrode 561, it is also possible to electrically isolate the movable electrode 562 and the movable conductive layer 552 from each other to make the movable electrode 562 and the movable conductive layer 552 function as electrodes independent of each other. In this case, for example, it is also possible to make the conductive layers 542, 552 of the respective reflecting films 54, 55 function as driving electrodes, and more accurate control of the gap G1 becomes possible in combination with the electrostatic actuator 56.

Although in the above description of the embodiments, there is described the example of forming the bump 511C by etching the first glass substrate M1 in the stationary substrate forming process, it is also possible to adopt a configuration of separately fixing the bump 511C to the third groove 511A. On this occasion, it is preferable to attach the bump 511C and the thick auxiliary section 511D made of resin to, for example, the third groove 511A. By forming the bump 511C and the thick auxiliary section 511D using the resin material, the contact pressure between the connection electrode 571 and the stationary terminal film 54C and the contact pressure between the connection electrode 572 and the stationary extraction electrode 561A can be released to the bump 511C or the thick auxiliary section 511D as resin, and thus, transmission of the stress to the stationary substrate 51 or the movable substrate 52 can be suppressed.

Although in the embodiments described above, there is adopted the configuration in which the gap dimension between the reflecting films 54, 55 can be changed by the electrostatic actuator 56, the invention is not limited to this configuration. For example, the invention can also be applied to a fixed wavelength Fabry-Perot etalon.

In the fixed wavelength interference filter, the movable section 521 and the holding section 522 as in the embodiments described above are not provided, and the distance between the stationary substrate 51 and the movable substrate 52 is kept constant. Even in such a case, by removing the charge of the stationary reflecting film 54 and the movable reflecting film 55, the distance between the reflecting films can be kept constant.

Although the spectroscopic measurement device 1 is cited in each of the embodiments described above as an example of the electronic apparatus according to the invention, the optical module and the electronic apparatus can be applied in a variety of fields besides the above.

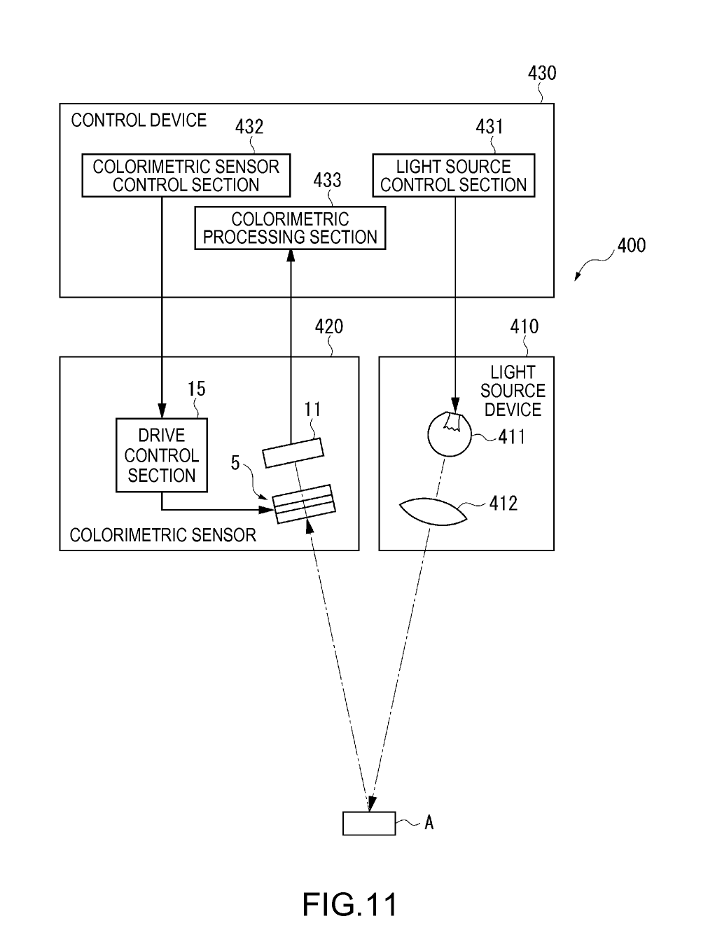

For example, as shown in FIG. 11, it is also possible to apply the electronic apparatus to a colorimetric device for measuring colors.

FIG. 11 is a block diagram showing an example of the colorimetric device 400 equipped with the variable wavelength interference filter.

As shown in FIG. 11, the colorimetric device 400 is provided with a light source device 410 for emitting light to the measurement object X, a colorimetric sensor 420 (an optical module), and a control device 430 for controlling an overall operation of the colorimetric device 400. Further, the colorimetric device 400 is a device for making the light, which is emitted from the light source device 410, be reflected by the measurement object X, receiving the test target light thus reflected using the colorimetric sensor 420, and analyzing and then measuring the chromaticity of the test target light, namely the color of the measurement object X, based on the detection signal output from the colorimetric sensor 420.

The light source device 410 is provided with a light source 411 and a plurality of lenses 412 (one of the lenses is shown alone in FIG. 11), and emits, for example, reference light (e.g., white light) to the measurement object X. Further, it is possible for the plurality of lenses 412 to include a collimator lens, and in this case, the light source device 410 converts the reference light emitted from the light source 411 into parallel light with the collimator lens, and then emits it from the projection lens not shown toward the measurement object X. It should be noted that although in the present embodiment the colorimetric device 400 provided with the light source device 410 is described as an example, in the case in which, for example, the measurement object X is a light emitting member such as a liquid crystal panel, it is also possible to adopt a configuration not provided with the light source device 410.

The colorimetric sensor 420 is the optical module according to an embodiment of the invention, and is provided with the variable wavelength interference filter 5, the detector 11 for receiving the light transmitted through the variable wavelength interference filter 5, and the drive control section 15 for varying the wavelength of the light to be transmitted through the variable wavelength interference filter 5 as shown in FIG. 11. Further, the colorimetric sensor 420 is provided with an entrance optical lens not shown disposed at a position opposed to the variable wavelength interference filter 5, the entrance optical lens guiding the reflected light (the test target light), which has been reflected by the measurement object X, into the inside thereof. Further, the colorimetric sensor 420 disperses the light with a predetermined wavelength out of the test target light input from the incident optical lens using the variable wavelength interference filter 5, and then receives the light thus dispersed using the detector 11. It should be noted that it is also possible to adopt a configuration in which the optical filter device 600 is disposed instead of the variable wavelength interference filter 5.

The control device 430 controls an overall operation of the colorimetric device 400.

As the control device 430, a general-purpose personal computer, a handheld terminal, a colorimetry-dedicated computer, and so on can be used. Further, as shown in FIG. 11, the control device 430 is configured including a light source control section 431, a colorimetric sensor control section 432, a colorimetric processing section 433, and so on.

The light source control section 431 is connected to the light source device 410, and outputs a predetermined control signal to the light source device 410 based on, for example, a setting input by the user to thereby make the light source device 410 emit white light with a predetermined brightness.

The colorimetric sensor control section 432 is connected to the colorimetric sensor 420, and sets the wavelength of the light to be received by the colorimetric sensor 420 based on, for example, the setting input by the user, and then outputs the control signal instructing to detect the intensity of the received light with the present wavelength to the colorimetric sensor 420. Thus, the drive control section 15 of the colorimetric sensor 420 applies the voltage to the electrostatic actuator 56 based on the control signal to thereby drive the variable wavelength interference filter 5.

The colorimetric processing section 433 analyzes the chromaticity of the measurement object X based on the received light intensity detected by the detector 11.

Further, as another example of the electronic apparatus, there can be cited an optical-base system for detecting presence of a specific material. As an example of such a system, there can be cited, for example, an in-car gas leak detector adopting a spectroscopic measurement method using the optical module according to an embodiment of the invention and detecting a specific gas with high sensitivity, and a gas detection device such as an optoacoustic noble-gas detector for a breath test.

An example of such a gas detection device will hereinafter be explained with reference to the accompanying drawings.

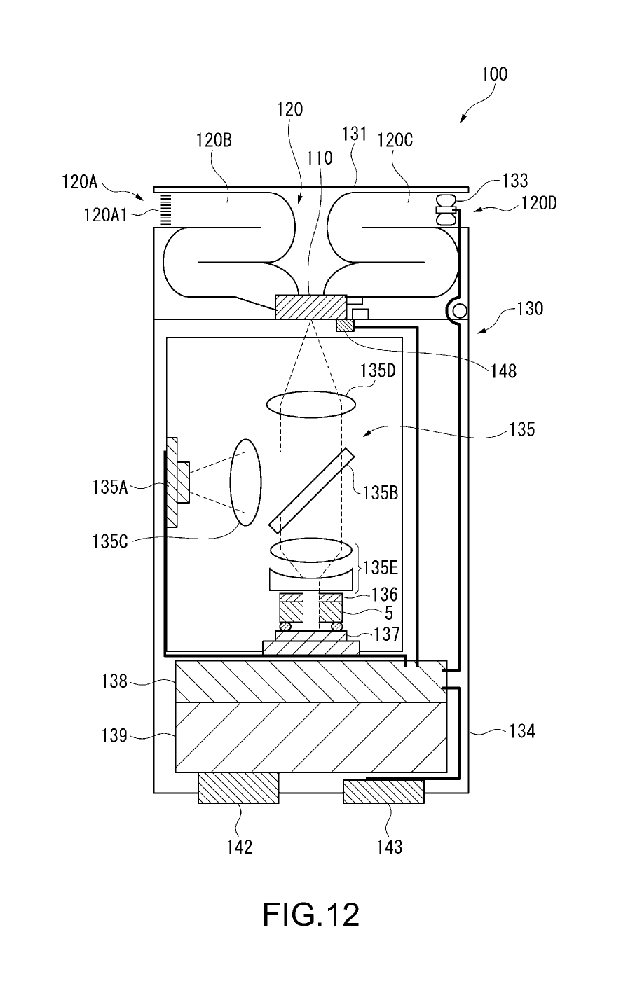

FIG. 12 is a schematic diagram showing an example of a gas detection device equipped with the optical module according to the invention.

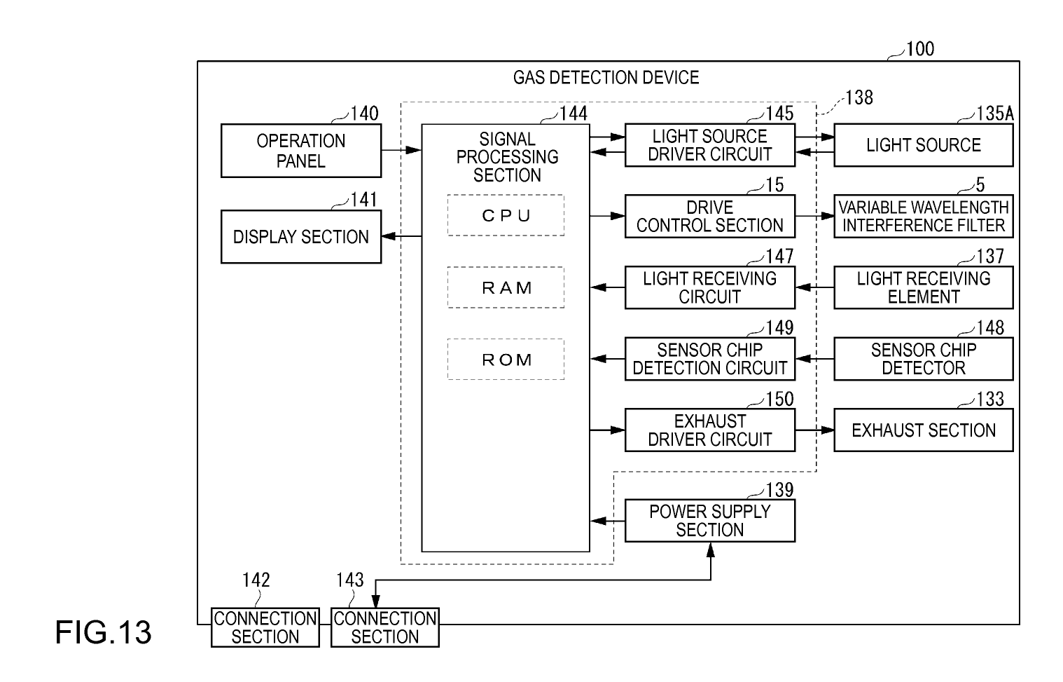

FIG. 13 is a block diagram showing a configuration of a control system of the gas detection device shown in FIG. 12.

As shown in FIG. 12, the gas detection device 100 is configured including a sensor chip 110, a channel 120 provided with a suction port 120A, a suction channel 120B, an exhaust channel 120C, and an exhaust port 120D, and a main body section 130.

The main body section 130 is composed of a detection device (an optical module) including a sensor section cover 131 having an opening to which the channel 120 is detachably attached, an exhaust section 133, a housing 134, an optical section 135, a filter 136, the variable wavelength interference filter 5, a light receiving element 137 (a light receiving section), and so on, a control section 138 (a processing section) for performing processing of the signal output in accordance with the light received by the light receiving element 137 and control of the detection device and the light source section, a power supply section 139 for supplying electrical power, and so on. It should be noted that it is also possible to adopt a configuration in which the optical filter device 600 is disposed instead of the variable wavelength interference filter 5. Further, the optical section 135 includes a light source 135A for emitting light, a beam splitter 135B for reflecting the light, which is input from the light source 135A, toward the sensor chip 110, and transmitting the light, which is input from the sensor chip side, toward the light receiving element 137, and lenses 135C, 135D, and 135E.

Further, as shown in FIG. 13, on the surface of the gas detection device 100, there are disposed an operation panel 140, a display section 141, a connection section 142 for an interface with an external device, and the power supply section 139. In the case in which the power supply section 139 is a secondary battery, a connection section 143 for the battery charge can also be provided.

Further, as shown in FIG. 13, the control section 138 of the gas detection device 100 is provided with a signal processing section 144 composed of a CPU and so on, a light source driver circuit 145 for controlling the light source 135A, the drive control section 15 for controlling the variable wavelength interference filter 5, a light receiving circuit 147 for receiving the signal from the light receiving element 137, a sensor chip detection circuit 149 for receiving the signal from a sensor chip detector 148 for reading a code of the sensor chip 110 to thereby detect presence or absence of the sensor chip 110, an exhaust driver circuit 150 for controlling the exhaust section 133, and so on.

Next, an operation of such a gas detection device 100 as described above will hereinafter be explained.

The sensor chip detector 148 is disposed inside the sensor section cover 131 in the upper part of the main body section 130, and the sensor chip detector 148 detects the presence or absence of the sensor chip 110. When detecting the detection signal from the sensor chip detector 148, the signal processing section 144 determines that it is the condition in which the sensor chip 110 is attached, and outputs a display signal for displaying the fact that the detection operation can be performed to the display section 141.

Then, in the case in which, for example, the user operates the operation panel 140, and the operation panel 140 outputs an instruction signal indicating that the detection process will be started to the signal processing section 144, the signal processing section 144 firstly outputs the signal for operating the light source to the light source driver circuit 145 to thereby operate the light source 135A. When the light source 135A is driven, the light source 135A emits a stable laser beam, which has a single wavelength and is a linearly polarized light. Further, the light source 135A incorporates a temperature sensor and a light intensity sensor, and the information of the sensors is output to the signal processing section 144. Then, if the signal processing section 144 determines that the light source 135A is operating stably based on the information of the temperature and the light intensity input from the light source 135A, the signal processing section 144 controls the exhaust driver circuit 150 to operate the exhaust section 133. Thus, the gaseous sample including the target material (the gas molecule) to be detected is guided from the suction port 120A to the suction channel 120B, the inside of the sensor chip 110, the exhaust channel 120C, and the exhaust port 120D. It should be noted that the suction port 120A is provided with a dust filter 120A1, and relatively large dust, some water vapor, and so on are removed.

Further, the sensor chip 110 is a sensor incorporating a plurality of sets of metal nano-structures, and using localized surface plasmon resonance. In such a sensor chip 110, an enhanced electric field is formed between the metal nano-structures due to the laser beam, and when the gas molecules enter the enhanced electric field, the Raman scattered light including the information of the molecular vibration, and the Rayleigh scattered light are generated.

The Rayleigh scattered light and the Raman scattered light pass through the optical section 135 and then enter the filter 136, and the Rayleigh scattered light is separated out by the filter 136, and the Raman scattered light enters the variable wavelength interference filter 5. Then, the signal processing section 144 outputs a control signal to the drive control section 15. Thus, the drive control section 15 drives the electrostatic actuator 56 of the variable wavelength interference filter 5 in a similar manner to the first embodiment described above to make the variable wavelength interference filter 5 disperse the Raman scattered light corresponding to the gas molecules to be the detection target. Subsequently, when the light thus dispersed is received by the light receiving element 137, the light reception signal corresponding to the received light intensity is output to the signal processing section 144 via the light receiving circuit 147. On this occasion, the Raman scattered light to be the target can accurately be taken out from the variable wavelength interference filter 5.

The signal processing section 144 compares the spectrum data of the Raman scattered light corresponding to the gas molecule to be the detection target obtained in such a manner as described above and the data stored in the ROM with each other to thereby determine whether or not the gas molecule is the target one, and thus identifies the substance. Further, the signal processing section 144 makes the display section 141 display the result information, or outputs the result information from the connection section 142 to the outside.

It should be noted that although in FIGS. 12 and 13 there is exemplified the gas detection device 100 for dispersing the Raman scattered light with the variable wavelength interference filter 5, and performing the gas detection based on the Raman scattered light thus dispersed, a gas detection device for identifying the gas type by detecting the absorbance unique to the gas can also be used. In this case, the gas sensor, which makes the gas flow into the sensor, and detects the light absorbed by the gas out of the incident light, is used as the optical module. Further, the gas detection device for analyzing and determining the gas flowing into the sensor using such a gas sensor is cited as the electronic apparatus. According also to such a configuration, it is possible to detect the component of the gas using the variable wavelength interference filter.

Further, as the system for detecting the presence of the specific substance, besides the gas detection described above, there can be cited a substance component analysis device such as a non-invasive measurement device of a sugar group using near-infrared dispersion, and a non-invasive measurement device of information of food, biological object, or mineral.

Hereinafter, a food analysis device will be explained as an example of the substance component analysis device described above.

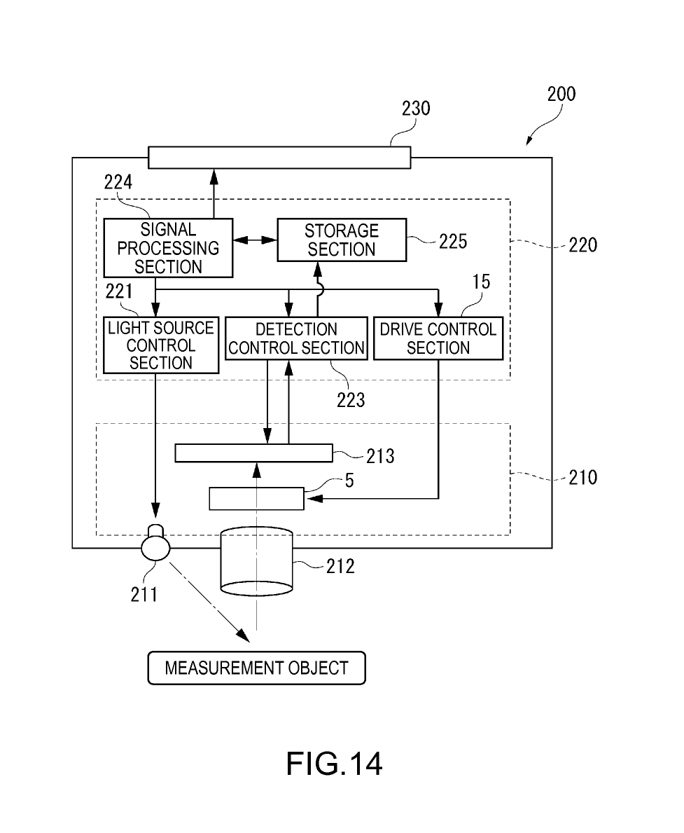

FIG. 14 is a diagram showing a schematic configuration of the food analysis device as an example of the electronic apparatus using the optical module according to the invention.

As shown in FIG. 14, the food analysis device 200 is provided with a detector 210 (the optical module), a control section 220, and a display section 230. The detector 210 is provided with a light source 211 for emitting light, an image pickup lens 212 to which the light from a measurement object is introduced, the variable wavelength interference filter 5 for dispersing the light thus introduced from the image pickup lens 212, and an image pickup section 213 (a light receiving section) for detecting the light thus dispersed. It should be noted that it is also possible to adopt a configuration in which the optical filter device 600 is disposed instead of the variable wavelength interference filter 5.

Further, the control section 220 is provided with a light source control section 221 for performing lighting/extinction control of the light source 211 and brightness control of the light source in the lighting state, the drive control section 15 for controlling the variable wavelength interference filter 5, a detection control section 223 for controlling the image pickup section 213 and obtaining a spectral image taken by the image pickup section 213, a signal processing section 224, and a storage section 225.

In the food analysis device 200, when the system is started up, the light source control section 221 controls the light source 211, and the light source 211 irradiates the measurement object with the light. Then, the light reflected by the measurement object passes through the image pickup lens 212 and then enters the variable wavelength interference filter 5. The variable wavelength interference filter 5 is driven with the driving method described in the first embodiment under the control by the drive control section 15. Thus, the light with the target wavelength can accurately be taken out from the variable wavelength interference filter 5. Then, the light thus taken out is imaged by the image pickup section 213 formed of, for example, a CCD camera. Further, the light thus imaged is stored in the storage section 225 as the spectral image. Further, the signal processing section 224 controls the drive control section 15 to vary the voltage value to be applied to the variable wavelength interference filter 5 to thereby obtain the spectral image corresponding to each wavelength.

Then, the signal processing section 224 performs an arithmetic process on the data of each pixel in each of the images stored in the storage section 225 to thereby obtain the spectrum in each pixel. Further, the storage section 225 stores, for example, information related to a component of food corresponding to the spectrum, and the signal processing section 224 analyzes the data of the spectrum thus obtained based on the information related to the food stored in the storage section 225, and then obtains the food component and the content thereof included in the detection object. Further, the calorie of the food, the freshness thereof, and so on can also be calculated based on the food components and the contents thus obtained. Further, by analyzing the spectral distribution in the image, it is possible to perform extraction of the portion with low freshness in the food as a test object, and further, it is also possible to perform detection of a foreign matter or the like included in the food.

Then, the signal processing section 224 performs a process of making the display section 230 display the information of the components, the contents, the calorie, the freshness, and so on of the food as the test object obtained in such a manner as described above.

Further, although the example of the food analysis device 200 is shown in FIG. 14, it is also possible to use substantially the same configuration as such a non-invasive measurement device of other information as described above. For example, the configuration can be used as a biological analysis device for performing analysis of a biological component such as measurement and analysis of a biological fluid such as blood. If a device of detecting ethyl alcohol is cited as a device for measuring the biological fluid component such as blood, such a biological analysis device can be used as a device for detecting the influence of alcohol to the driver to thereby prevent driving under the influence of alcohol. Further, the configuration can also be used as an electronic endoscopic system equipped with such a biological analysis device.

Further, the configuration can also be used as a mineral analysis device for performing component analysis of minerals.

Further, the optical module and the electronic apparatus can be applied to the following devices.

For example, it is also possible to transmit data with the light having each of the wavelengths by temporally varying the intensity of the light having each of the wavelengths, and in this case, it is possible to extract the data transmitted with the light having a specific wavelength by dispersing the light having the specific wavelength using the variable wavelength interference filter provided to the optical module, and then making the light receiving section receive the light. Therefore, by processing the data in the light having each of the wavelengths using the electronic apparatus equipped with such a data extracting optical module, it is also possible to perform optical communication.

Further, the electronic apparatus can be applied to a spectroscopic camera for picking up the spectral image and a spectroscopic analysis device by dispersing the light with the optical module. As an example of such a spectroscopic camera, an infrared camera incorporating the variable wavelength interference filter can be cited.

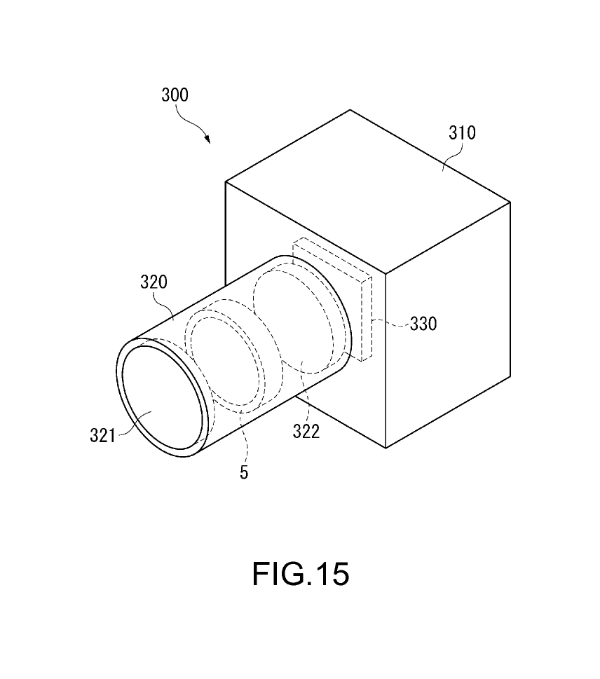

FIG. 15 is a schematic diagram showing a schematic configuration of the spectroscopic camera. As shown in FIG. 15, the spectroscopic camera 300 is provided with a camera main body 310, an image pickup lens unit 320, and an image pickup section 330.

The camera main boy 310 is a part to be gripped and operated by the user.

The image pickup lens unit 320 is provided to the camera main body 310, and guides the image light input thereto to the image pickup section 330. Further, as shown in FIG. 15, the image pickup lens unit 320 is configured including an objective lens 321, an imaging lens 322, and the variable wavelength interference filter 5 disposed between these lenses. It should be noted that it is also possible to adopt a configuration in which the optical filter device 600 is disposed instead of the variable wavelength interference filter 5.

The image pickup section 330 is formed of a light receiving element, and takes the image of the image light guided by the image pickup lens unit 320.

In such a spectroscopic camera 300, by transmitting the light with the wavelength to be the imaging object using the variable wavelength interference filter 5, the spectral image of the light with a desired wavelength can be taken.

Further, the optical module can be used as a band-pass filter, and can also be used as, for example, an optical laser device for dispersing and transmitting only the light with a wavelength in a narrow band centered on a predetermined wavelength out of the light in a predetermined wavelength band emitted by the light emitting element using the variable wavelength interference filter.

Further, the optical module can also be used as a biometric authentication device, and can be applied to, for example, an authentication device of blood vessels, a fingerprint, a retina, an iris, and so on using the light in a near infrared range or a visible range.

Further, the optical module and the electronic apparatus can be used as a concentration detection device. In this case, the infrared energy (the infrared light) emitted from the substance is dispersed by the variable wavelength interference filter and is then analyzed, and the concentration of the test object in a sample is measured.

As described above, the optical module and the electronic apparatus can be applied to any device for dispersing predetermined light from the incident light. Further, since the optical module can disperse the light into a plurality of wavelength components with a single device as described above, the measurement of the spectrum of a plurality of wavelengths and detection of a plurality of components can be performed with accuracy. Therefore, compared to the related-art device of taking out desired wavelengths with a plurality of devices, miniaturization of the optical module and the electronic apparatus can be promoted, and the optical module and the electronic apparatus can preferably be used as, for example, a portable or in-car optical device.

Besides the above, a specific structure to be adopted when putting the invention into practice can be replaced with another structure and so on within the range in which the advantages of the invention can be achieved.

The entire disclosure of Japanese Patent Application No. 2013-201045 filed on Sep. 27, 2013 is expressly incorporated by reference herein.

What is claimed is:

1. An interference filter comprising:
a first reflecting film formed of a plurality of layers, the plurality of layers including a first conductive outermost layer; and
a second reflecting film opposed to the first reflecting film,
wherein the first reflecting film includes a first region facing the second reflecting film and a second region extending outwardly from an outer circumferential edge of the first region, and
the first conductive layer includes a first terminal in the second region.

2. The interference filter according to claim 1, wherein
the second reflecting film is formed of a second plurality of layers including a second conductive outermost layer, and includes a third region facing the first region of the first reflecting film, and a fourth region extending outwardly from an outer circumferential edge of the third region, and
the second conductive layer includes a second terminal in the fourth region.

3. The interference filter according to claim 2, further comprising:
a first substrate provided with the first reflecting film;
a second substrate provided with the second reflecting film, the second substrate being opposed to the first substrate;
a first electrode provided to the first substrate; and
a second electrode provided to the second substrate, the second electrode being opposed to the first electrode,
wherein the first electrode is disposed outside the first region in a plan view, and
the second electrode is disposed on the second conductive layer.

4. The interference filter according to claim 3, wherein
a first gap dimension between the first electrode and the second electrode is smaller than a second gap dimension between the first conductive layer in the first region and the second conductive layer in the third region.

5. The interference filter according to claim 1, wherein
the first conductive layer comprises a metal oxide having a light transmissive property with respect to a predetermined wavelength band.

6. The interference filter according to claim 5, wherein
the first terminal is provided with a metal film.

7. The interference filter according to claim 6, further comprising:
a first substrate provided with the first reflecting film;
a second substrate provided with the second reflecting film; and
an electrode disposed on at least one of the first substrate and the second substrate,
wherein the electrode and the metal film are formed of the same material.

8. The interference filter according to claim 1, further comprising:
a substrate provided with the second reflecting film,
wherein the second substrate is provided with a connection electrode connected to the first terminal of the first conductive layer.

9. The interference filter according to claim 1, wherein
the first reflecting film and the second reflecting film are each formed of a multilayer film having high refractive index layers and low refractive index layers alternately stacked on each other.

10. An optical filter device comprising:
the interference filter according to claim 1; and
a housing holding the interference filter.

11. An optical module comprising:
the interference filter according to claim 1; and
a light receiving section receiving light emitted from the interference filter.

12. An electronic apparatus comprising:
the interference filter according to claim 1; and
a control section controlling the interference filter.

13. An interference filter comprising:
a first substrate;
a second substrate opposed to the first substrate;
a first reflecting film on the first substrate, the first reflecting film being formed of a plurality of layers, the plurality of layers including a first conductive outermost layer;
a second reflecting film on the second substrate, the second reflecting film being formed of a second plurality of layers including a second conductive outermost layer;
a first electrode provided to the first substrate; and
a second electrode provided to the second substrate, the second electrode being opposed to the first electrode,
wherein the first reflecting film includes a first region facing the second reflecting film and a second region extending outwardly from an outer circumferential edge of the first region,
the second reflecting film includes a third region facing the first region of the first reflecting film, and a fourth region extending outwardly from an outer circumferential edge of the third region,
the first conductive layer includes a first terminal in the second region,
the second conductive layer includes a second terminal in the fourth region,
the first electrode is disposed outside the first region in a plan view, and
the second electrode is disposed on the second conductive layer.

14. The interference filter according to claim 13, wherein
a first gap dimension between the first electrode and the second electrode is smaller than a second gap dimension between the first conductive layer in the first region and the second conductive layer in the third region.

15. The interference filter according to claim 13, wherein
the first conductive layer comprises a metal oxide having a light transmissive property with respect to a predetermined wavelength band.

16. The interference filter according to claim 15, wherein
the first terminal is provided with a metal film.

17. The interference filter according to claim 16, wherein
the first electrode, the second electrode, and the metal film are formed of the same material.

18. The interference filter according to claim 13, wherein
the second substrate is provided with a connection electrode connected to the first terminal of the first conductive layer.

19. The interference filter according to claim 13, wherein
the first reflecting film and the second reflecting film are each formed of a multilayer film having high refractive index layers and low refractive index layers alternately stacked on each other.
